(19) United States
(12) Patent Application Publication
(10) Pub. No.: US 2015/0339871 A1
(43) Pub. Date: Nov. 26, 2015

(54) ENTITY MANAGEMENT AND RECOGNITION SYSTEM AND METHOD

(71) Applicant: ALTITUDE CO., San Francisco, CA (US)

(72) Inventors: Akiva WAGNER, San Francisco, CA (US); Sohrab MEMARI, Sydney (AU); Marco Filipe Couto Amado FERREIRA, Lisbon (PT); Yisroel Kirsh, San Francisco, CA (US)

(73) Assignee: ALTITUDE CO., San Francisco, CA (US)

(21) Appl. No.: 14/713,920

(22) Filed: May 15, 2015

Related U.S. Application Data
(60) Provisional application No. 61/993,556, filed on May 15, 2014.

(51) Int. Cl. G07C 9/00

(52) U.S. Cl. CPC G07C 9/00087

(57) ABSTRACT

A system and method for wirelessly monitoring and recognizing people and things is disclosed. An entity monitoring and recognition (EMAR) unit at a site detects the presence of the entity, and in response the unit recognizes the entity and triggers an action, wherein the detection and recognition comprises the EMAR unit wirelessly communicating with a device associated with the entity without any action on the part of the entity. A site is a physical location, including a budding. The system also stores detection and recognition events and associates them with the entity, the time of the detection and recognition, and a touchpoint within the site at which the detection and recognition occurred.

### RELATED APPLICATIONS

This application claims priority from U.S. Provisional Application No. 61/993,556, filed May 15, 2014.

### FIELD OF THE INVENTION

The invention is in the field of wireless collection of information-based data.

### BACKGROUND

Wireless communication technology continues to develop, as does the use of electronic devices to identify and track people and things. For example, these developments enable to person to receive an airline ticket electronically on a cell phone, and present the cell phone instead of a paper ticket when boarding a plane. As another example, electronic door locks can be unlocked with a card key. Currently, these systems make it more convenient to do many things. However, conventionally, more than one system and/or device is required to perform various functions. For example, a person may hold a card key for entering a building, but in order to speed plane boarding, a cell phone app is used.

### BRIEF DESCRIPTION OF THE DRAWINGS

FIG. 1 is a block diagram of an entity monitoring and recognition system according to an embodiment.

FIG. 2 is a block diagram of various processes that are executed on the servers of the entity monitoring and recognition system according to an embodiment.

FIG. 3 is a block diagram illustrating various possible system participants according to an embodiment.

FIG. 4 is a diagram of an entity monitoring and recognition system unit housing according to an embodiment

FIG. 5 is a diagram of a battery powered entity monitoring and recognition unit beacon according to an embodiment.

FIG. 6 is an API data model according to an embodiment.

FIGS. 7A-7N are diagrams illustrating operation of an entity monitoring and recognition system that uses a handset (phone) as a relay.

FIGS. 8A-8L are diagrams illustrating operation of an entity monitoring and recognition system according to an alternate embodiment in which the device has its own connection to the entity monitoring and recognition system server.

FIGS. 9-17 show example user interface screens for an entity monitoring and recognition mobile app on a device.

FIG. 18 is a screen shot from an administrator application according to an embodiment.

FIGS. 19-34 are screen shots of an administrative application or “dashboard” that can be used by a building administrator to manage an entity monitoring and recognition system.

### DETAILED DESCRIPTION

Embodiments of the invention include proximity based hardware and software, referred to herein an entity management and recognition (EMAR) system. The EMAR system enables automatic identification of users by other people and devices.

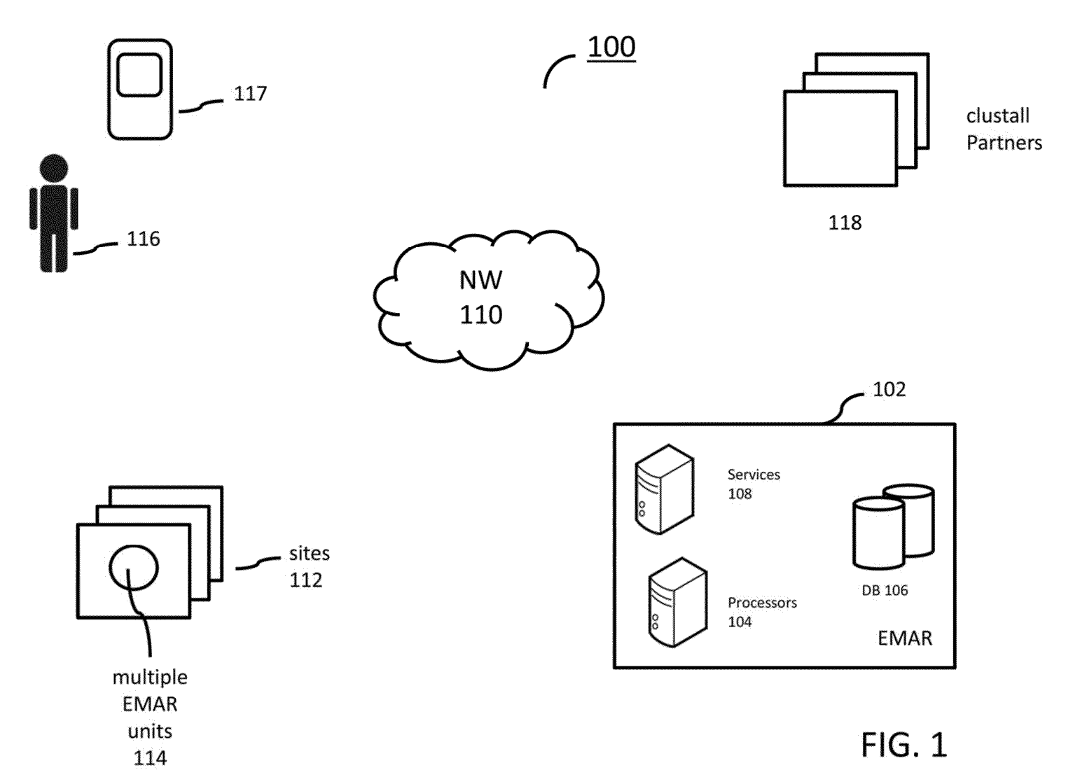

FIG. 1 is a block diagram of an EMAR system 100. The system 100 includes a EMAR backend systems 102, including various servers 108, data storage 106, and processors 104. The elements of the backend systems 102 are shown in one location, but in fact can be distributed anywhere over a network 110. Network 110 includes any communication networks that are used by the EMAR system components as further described herein, including the Internet, LANS, WANs, and so on. The EMAR system components communicate over these networks using any wireless protocols (e.g., Bluetooth, Bluetooth Low Energy (BLE), etc.).

The EMAR system includes multiple EMAR units 114 that are deployed in various sites 112. Installer partners 118 include companies that install software and hardware to communicate with the EMAR system components and participate in the EMAR system. Entities 116 can be humans, as shown. However, in various embodiments, an entity 116 can be anything it is desirable to monitor and identify. Devices of identity (DOI) 117 include, but are not limited to smartphones, glasses, wearable devices (e.g., wristbands), watches, clothing, and chips in a body. DOE 117 communicates with EMAR units 114 as further described below.

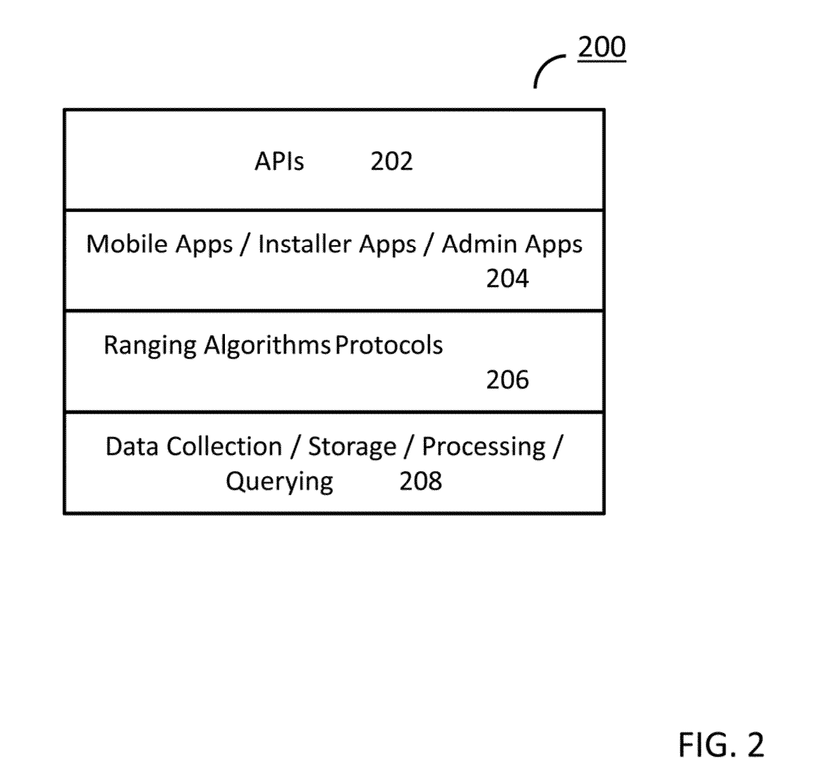

FIG. 2 is a block diagram of various processes that are executed on the servers 108. They include application programming interface APIs) 202 that facilitate the communication of external systems with the EMAR system 100, and also facilitate various programming functions. Apps 204, as described in more detail below, include user interfaces for entitles and installers to interact with the EMAR system 100. They include, but are not limited to mobile apps, installer apps, and administrative apps.

Ranging algorithms and protocols 206 are used to track the location of entities. Various other backend processes 208 include, but are not limited to data collection, data storage, data processing and database querying.

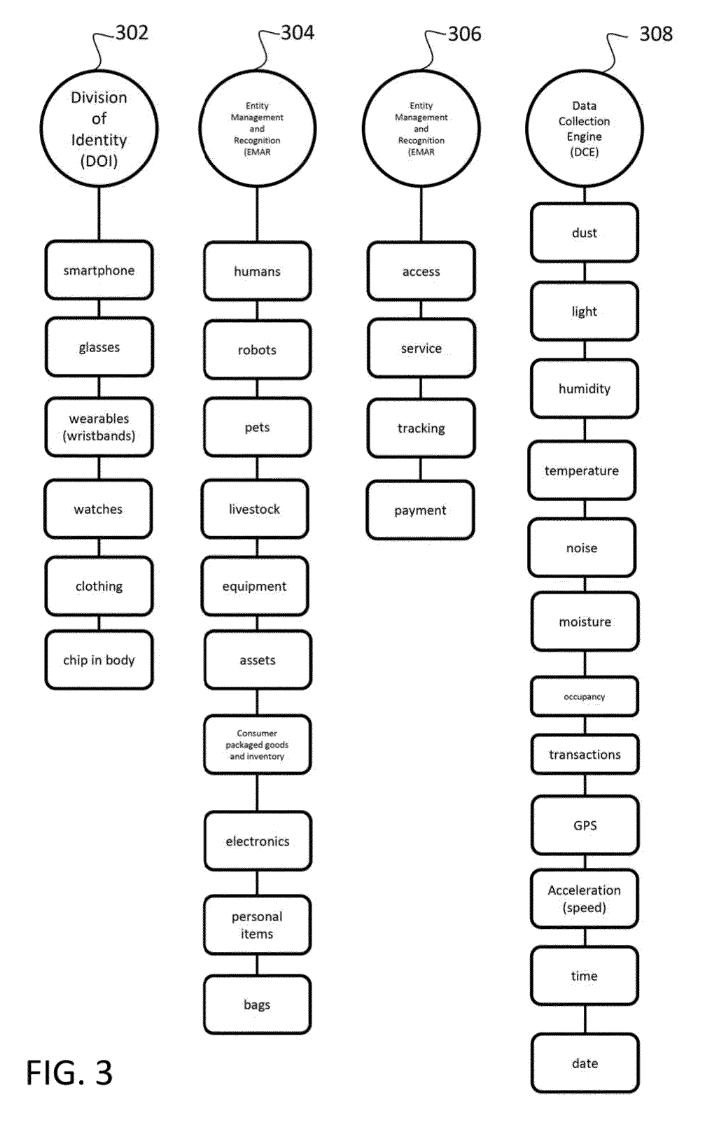

FIG. 3 is a block diagram illustrating various possible system participants. A device of identity (DOE) 302 can be understood as the object that is recognized and monitored by an EMAR unit. Devices 302 include, but are not limited to smartphones, glasses, wearable devices (e.g., wristbands), watches, clothing, and chips in a body.

Entities 304 that can be managed and recognized by the EMAR system include bat are not limited to humans, robots, pets, livestock, equipment, assets, consumer packaged goods and inventory, electronic, personal items, and bags.

Actions 306 that can be automated by identity based automation (IBA) include but are not limited to access, service, tracking, and payment.

Data items 308 that can be collected by data collection engine (DCE) include but are not limited to data regarding: dust, light, humidity, temperature, noise, moisture, occupancy, transactions, global positioning system (GPS) gyroscopic movement, speed or acceleration, time and data.

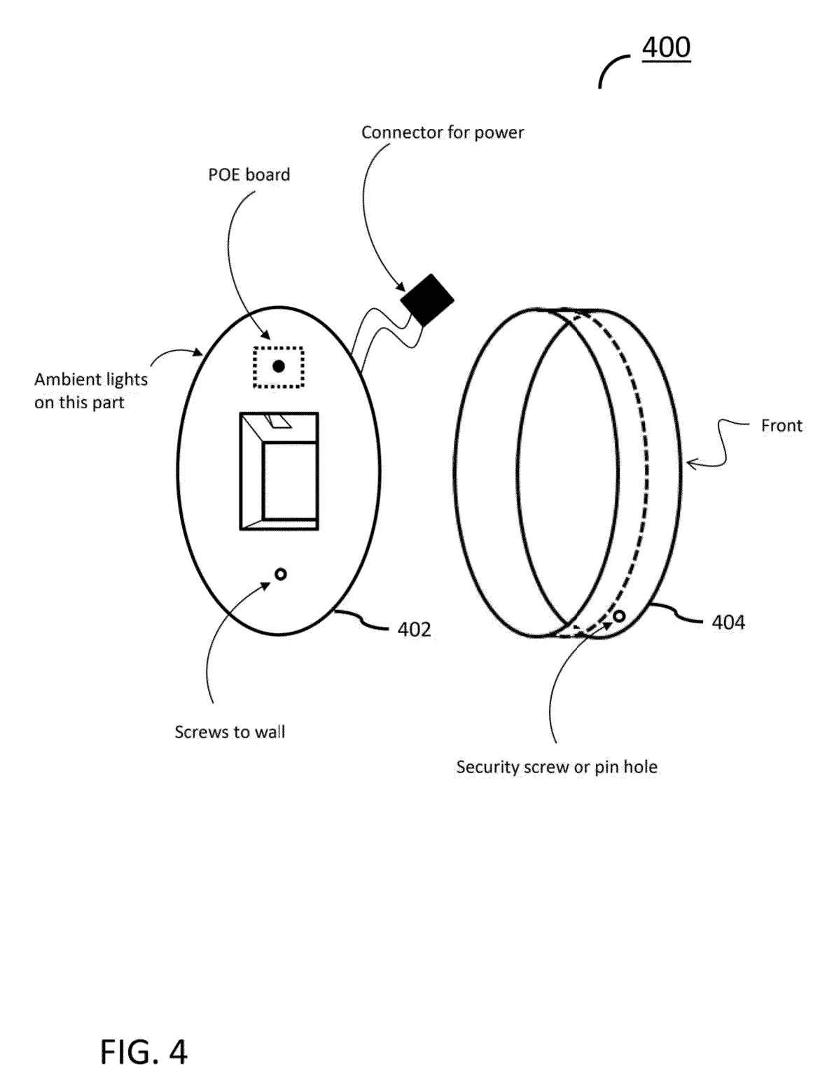

FIG. 4 is a diagram of an EMAR unit 114 housing 400 according to an embodiment. Components of housing 400 include a housing back 402 and a housing front 404. In an embodiment, the housing back 402 is screwed to a surface and contains a power over Ethernet (POE) board 406 that is not exposed to tampering, and a power connector 408. In other embodiments the EMAR unit can operate on battery power or some other alternative power scarce.

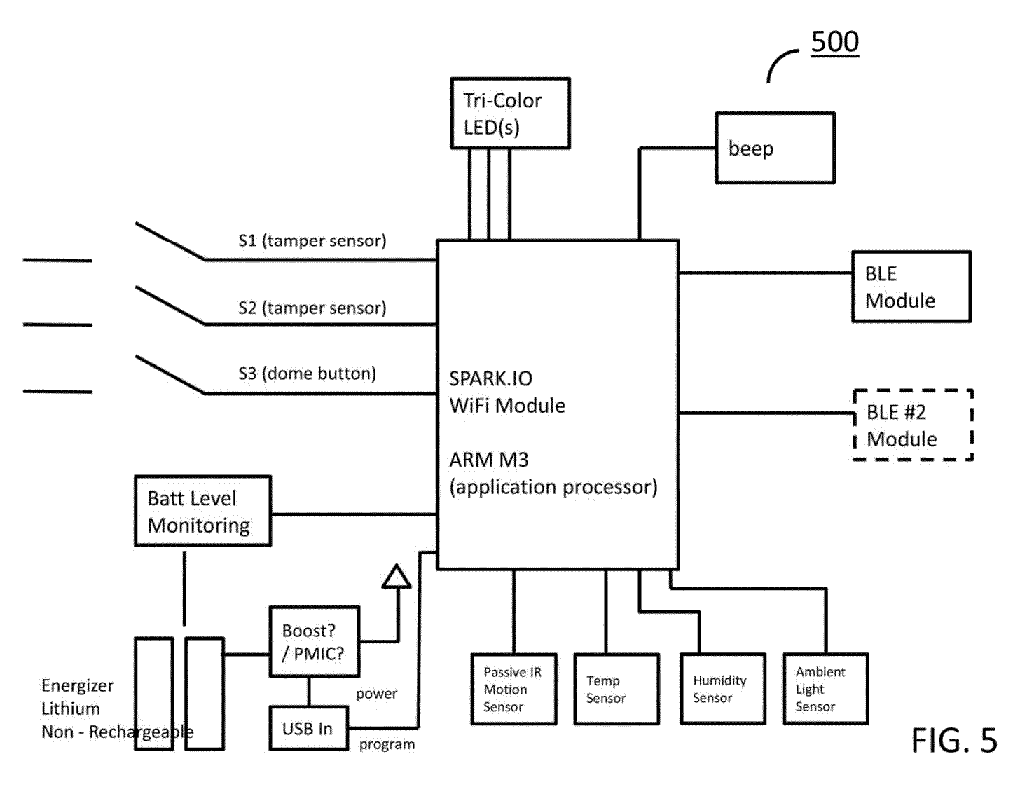

FIG. 5 is a diagram of a battery powered EMAR unit beacon 500 according to an embodiment. The beacon 500 is operated by a battery driven WiFi module, which in an embodiment is an ARM M3 application processor, however embodiments are not so limited. Tamper sensors, dome lights, tricolor LEDs and an audio unit (beep) are operated by the WiFi module. One or more Bluetooth low energy (BLE) modules are also operated by the WiFi module. Many sensors can be controlled by the WiFi module, including but not limited to an infra-red motion sensor, a temperature sensor, a humidity sensor and an ambient light sensor. In an embodiment, a USB connection: is available for programming the WiFi module to perform functions as further described below.

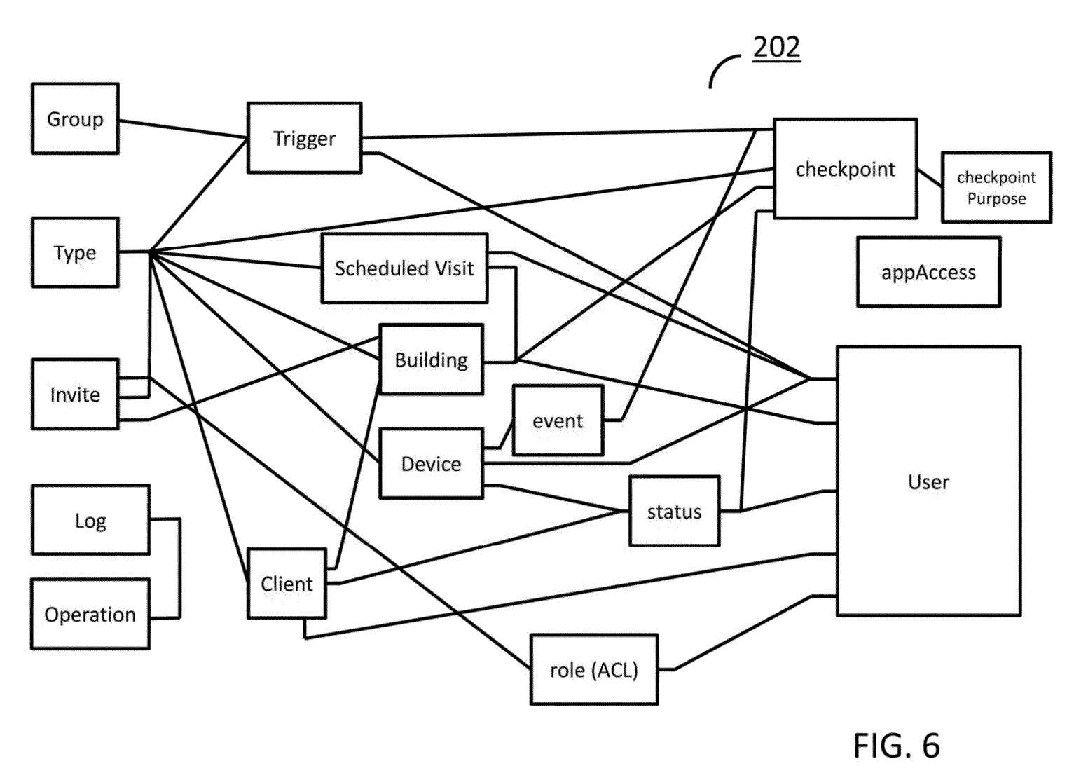

FIG. 6 illustrates an embodiment of an API data model 202, The diagram illustrates various defined entities and their interactions. For example, “group” interacts with “trigged”, and “trigger” interacts with “checkpoint” and “used”. Not shown within each entity are the relevant variables for each, for example: id INTEGER, name VARCHAR, users ARRAY, etc.

### Example System Deployment: Entity Management and Recognition in Buildings

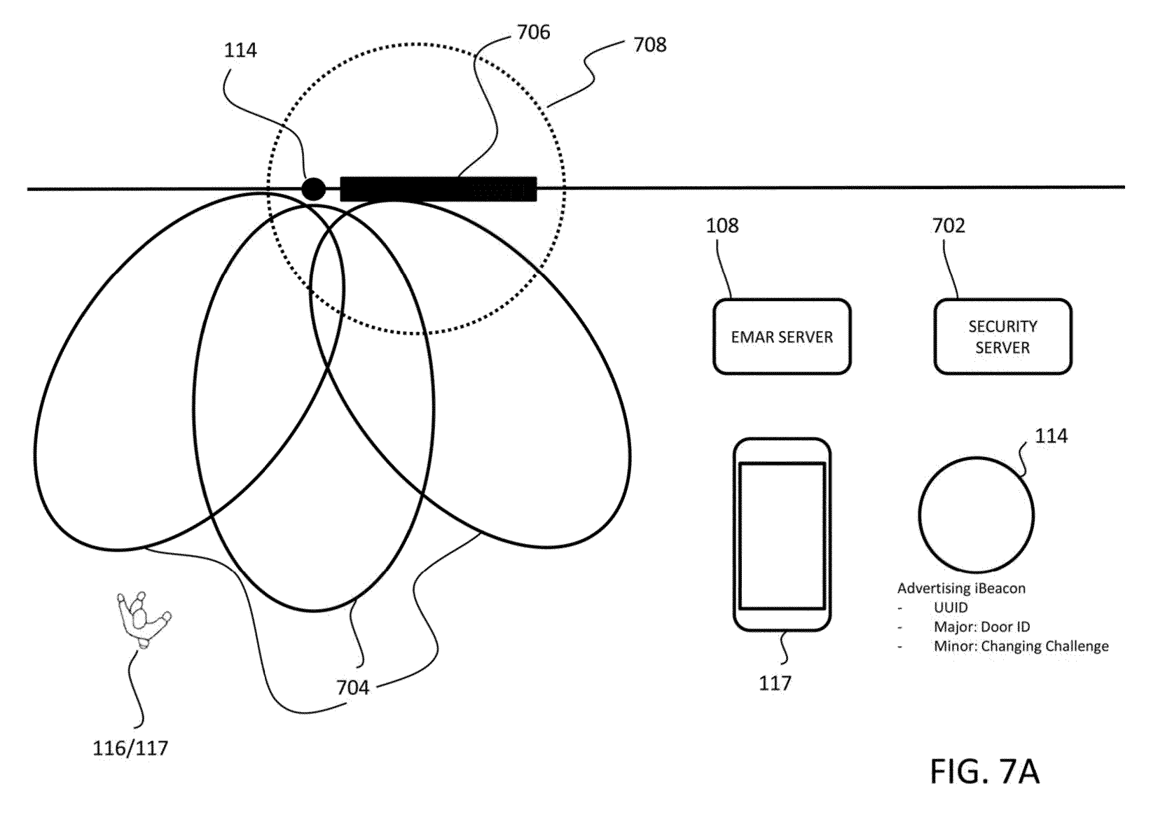

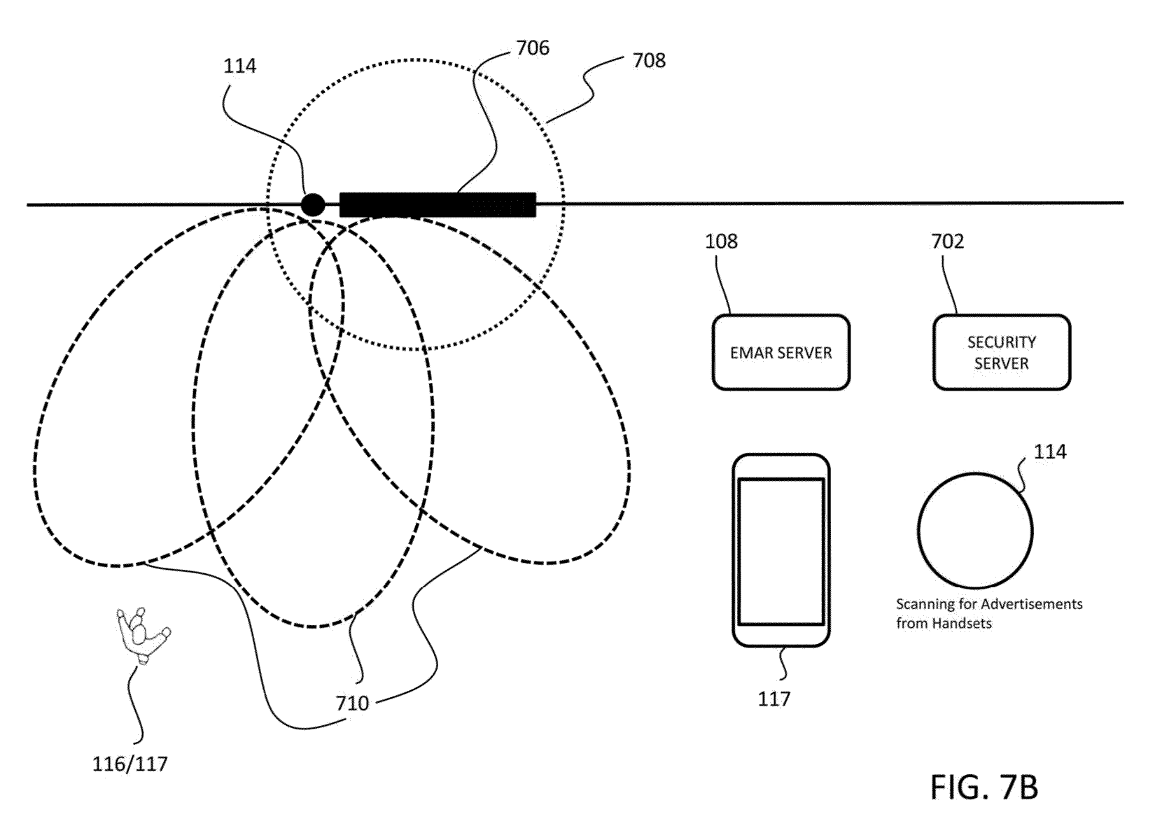

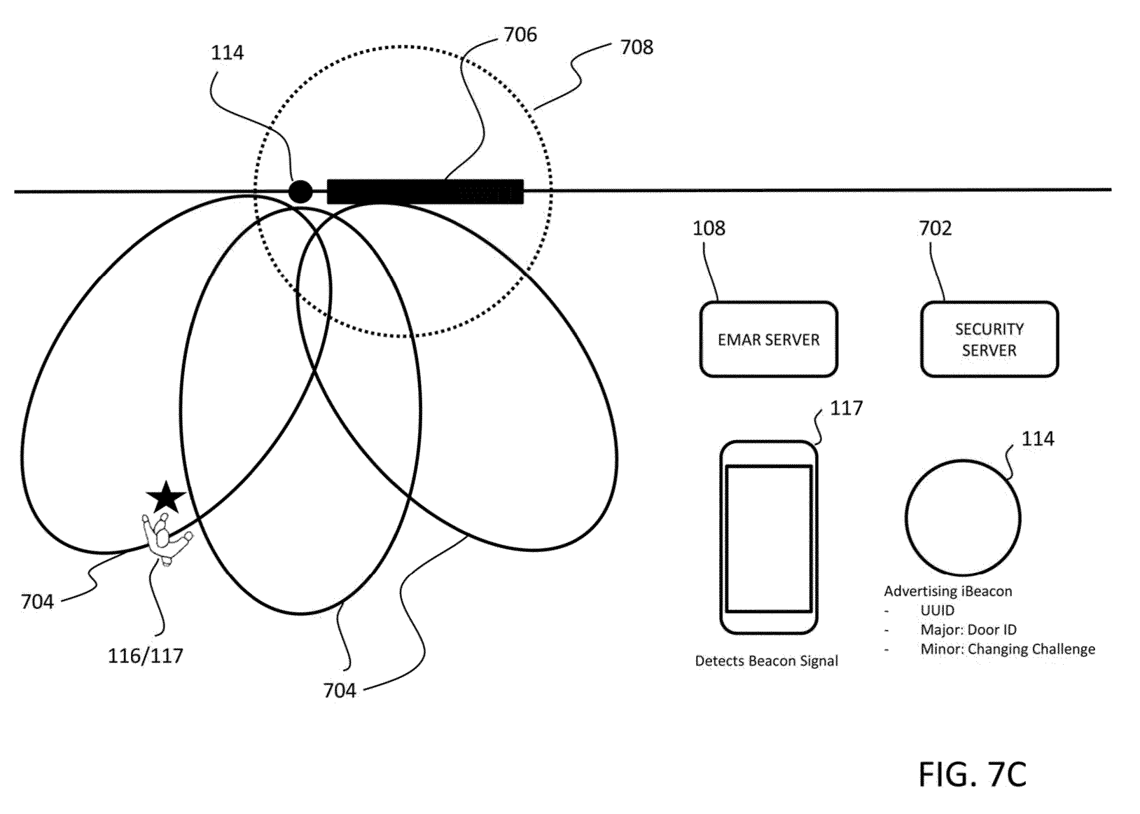

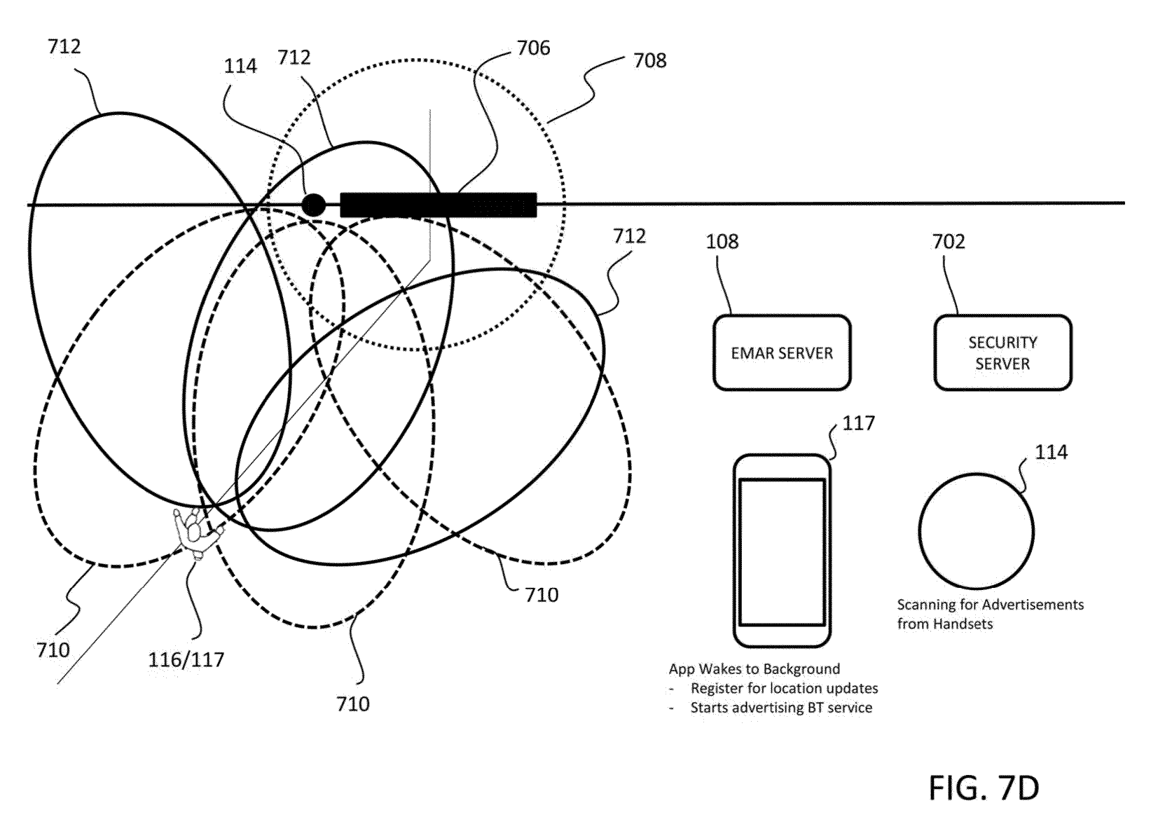

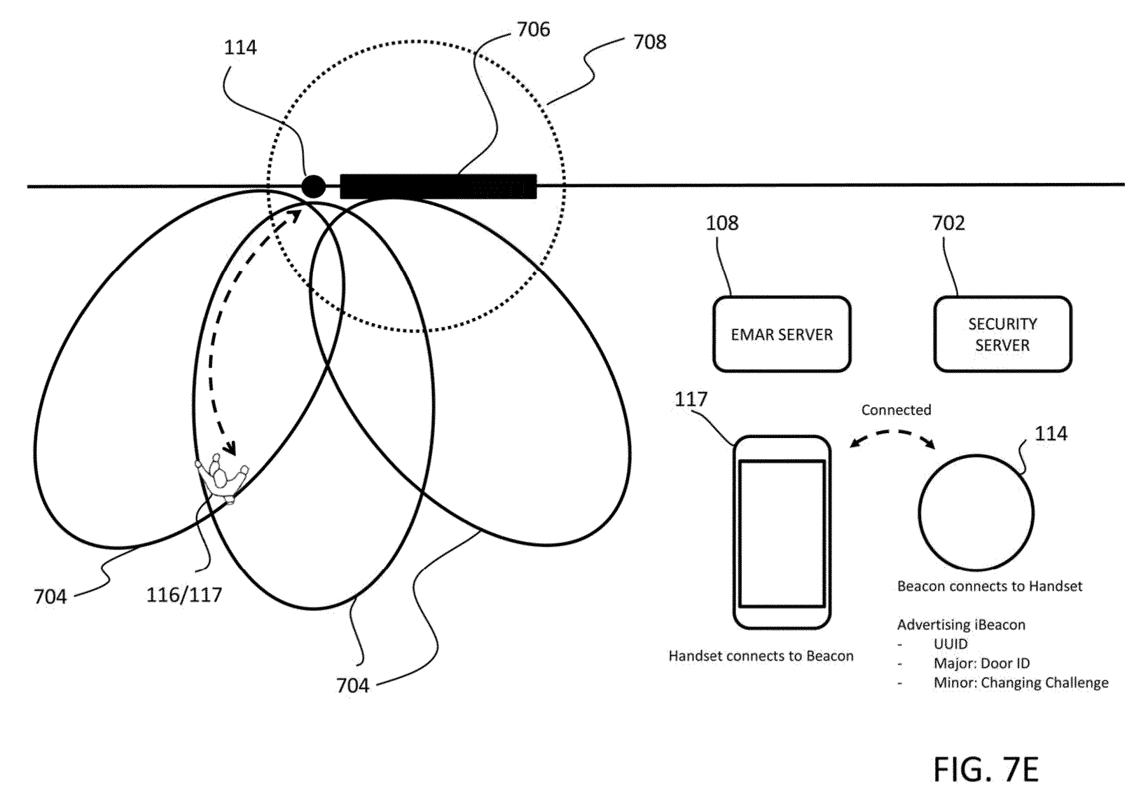

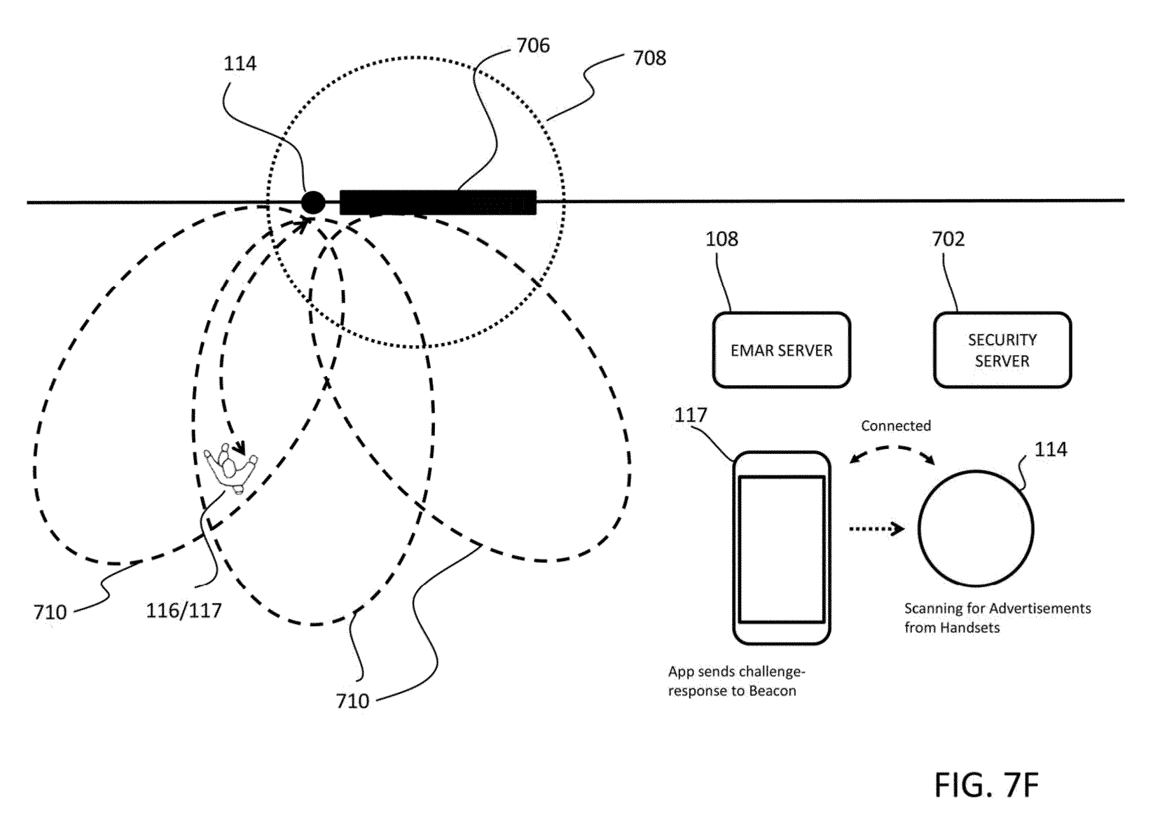

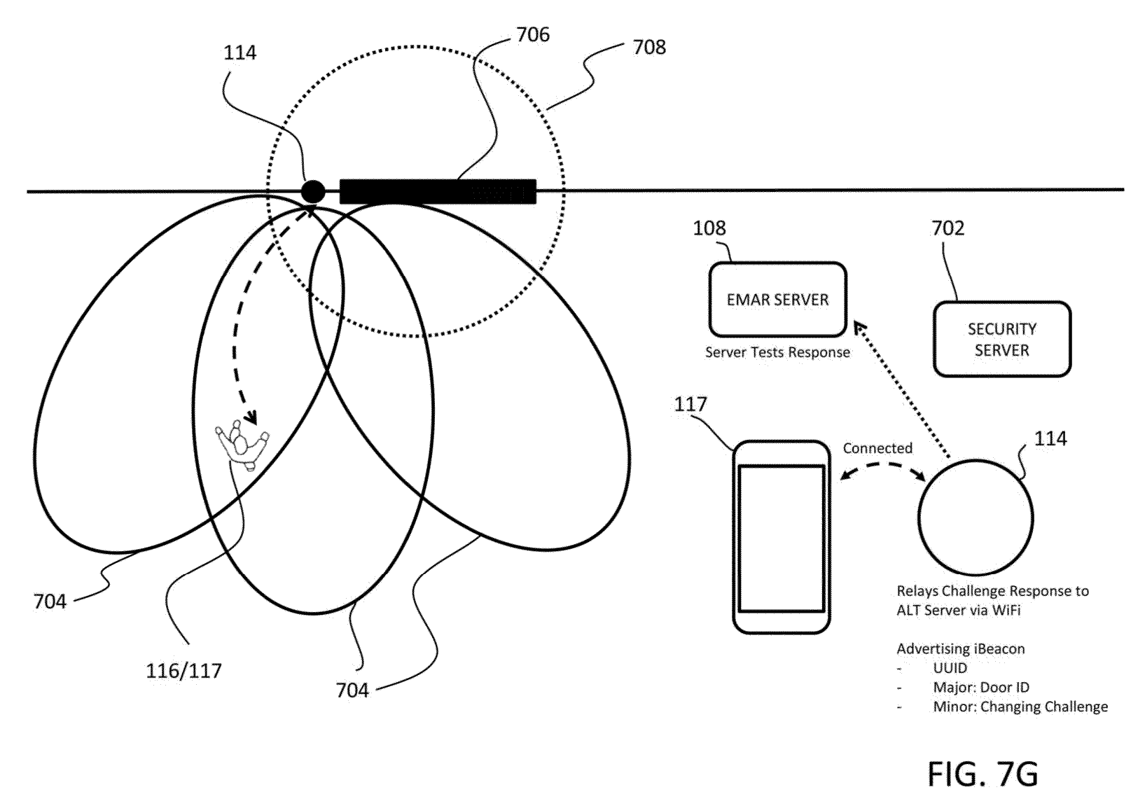

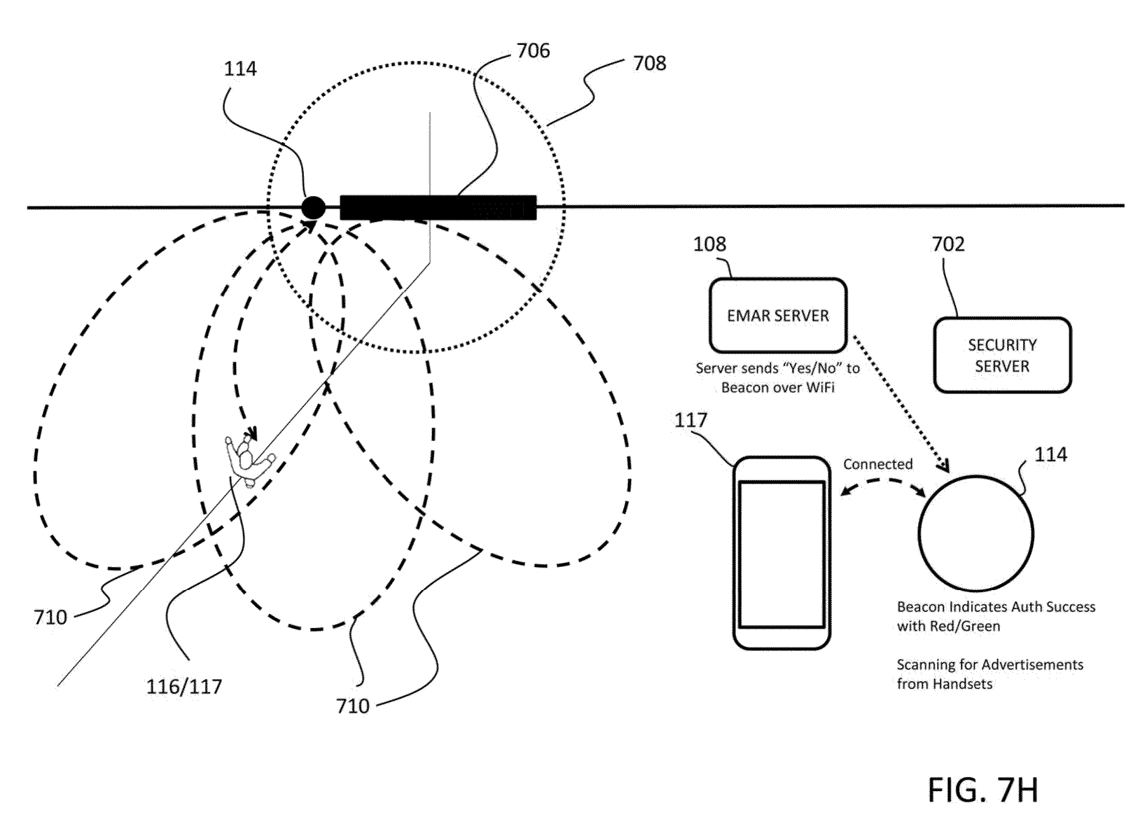

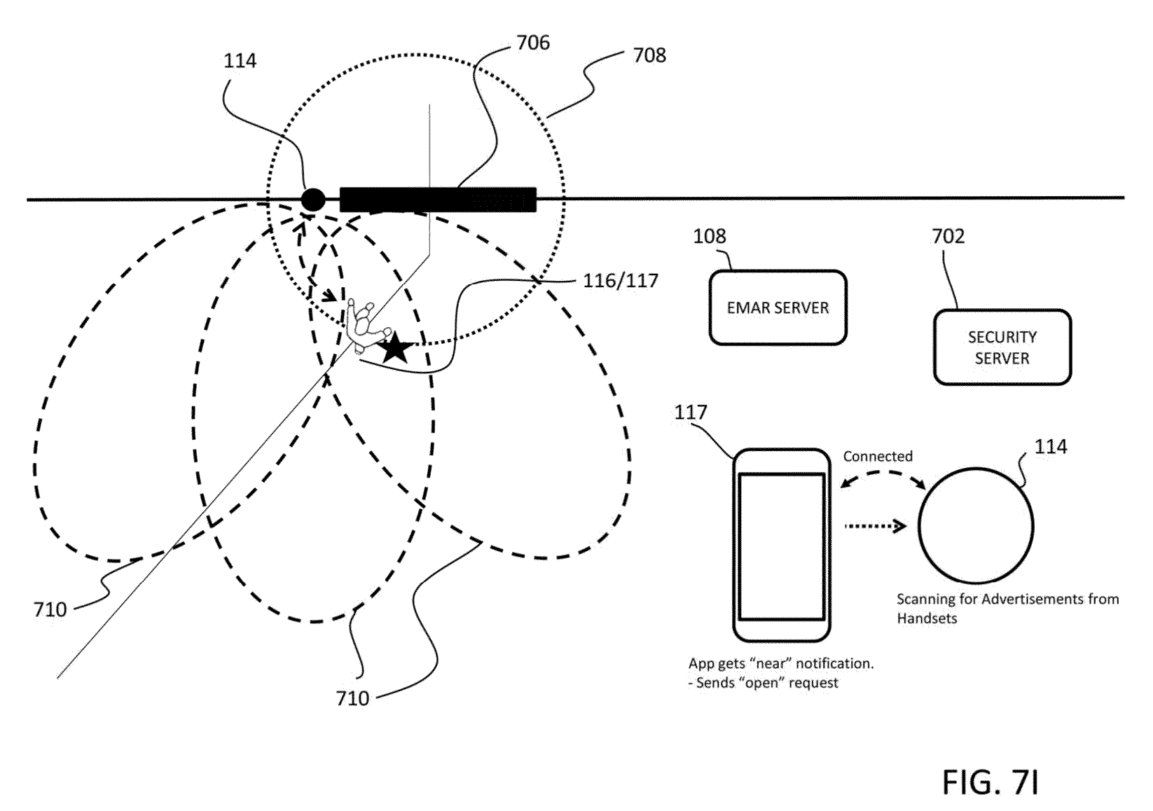

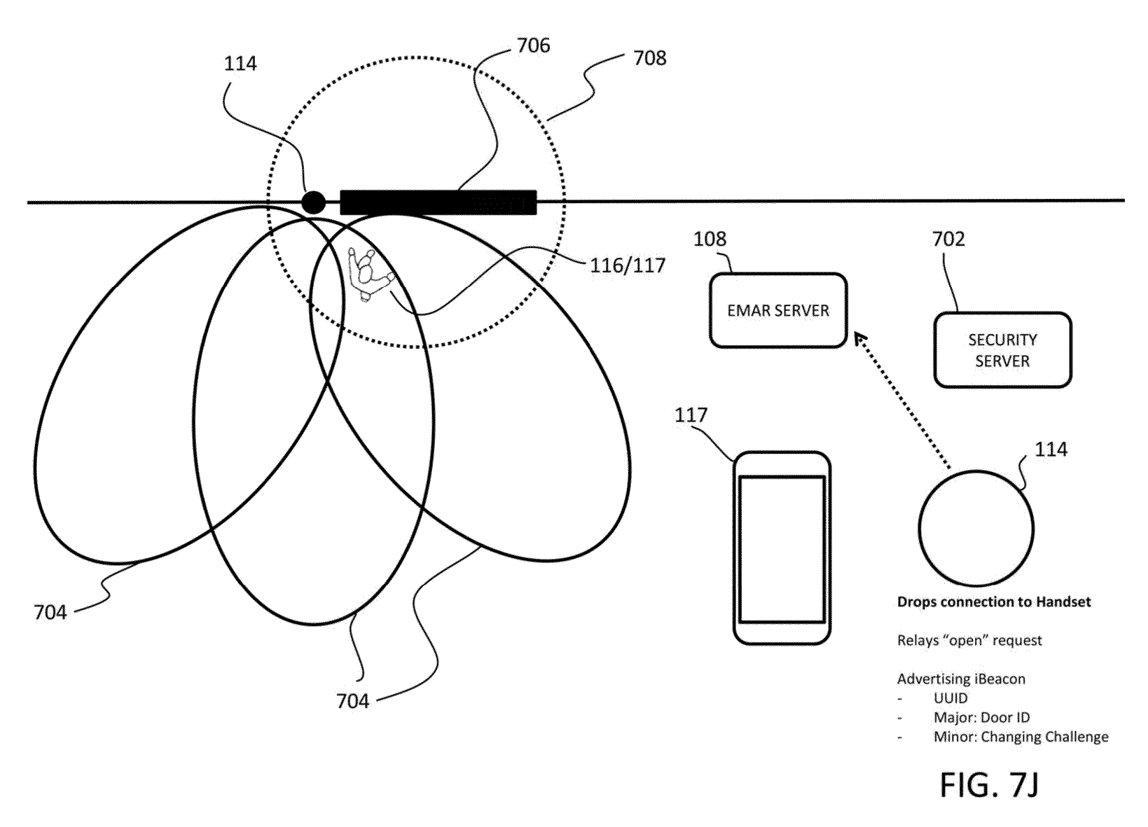

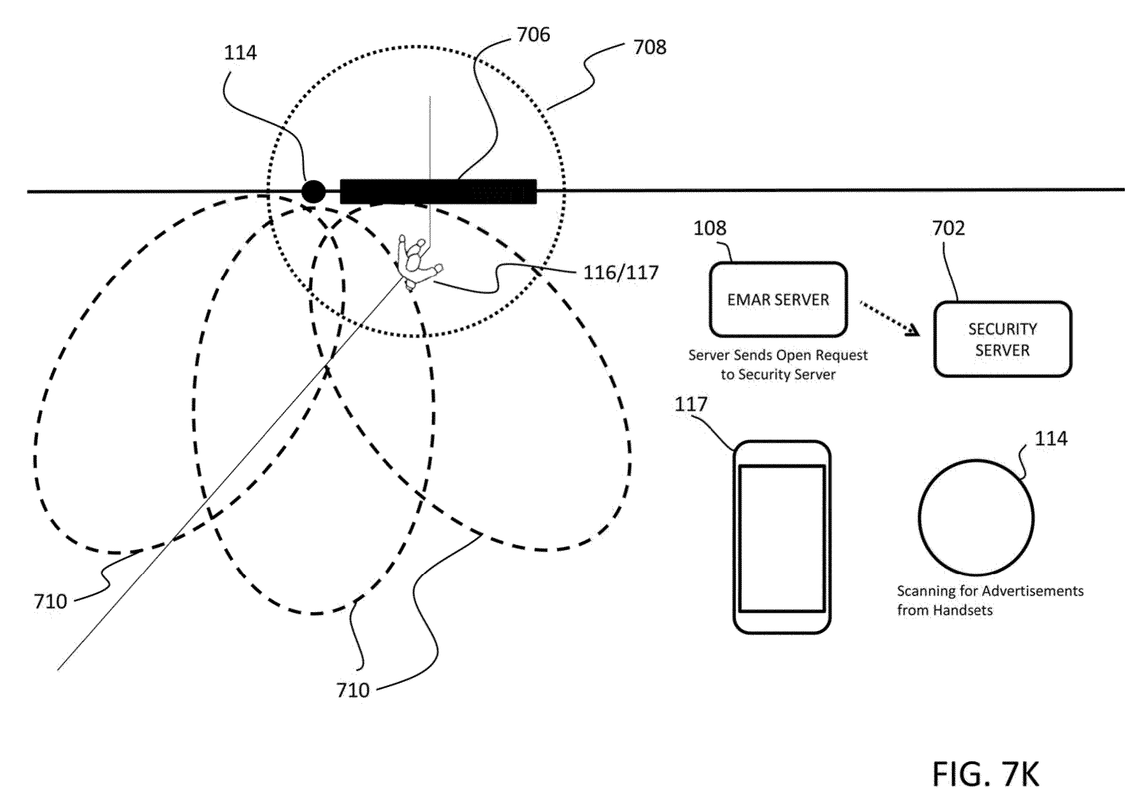

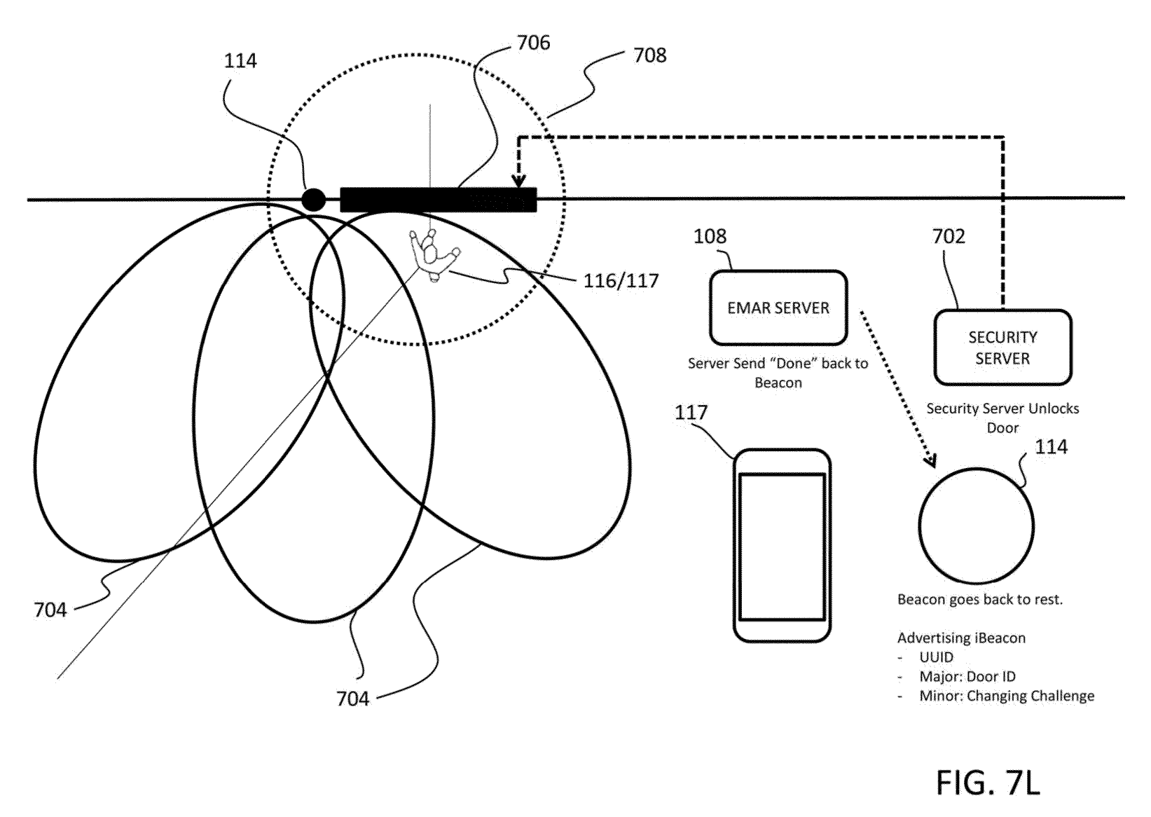

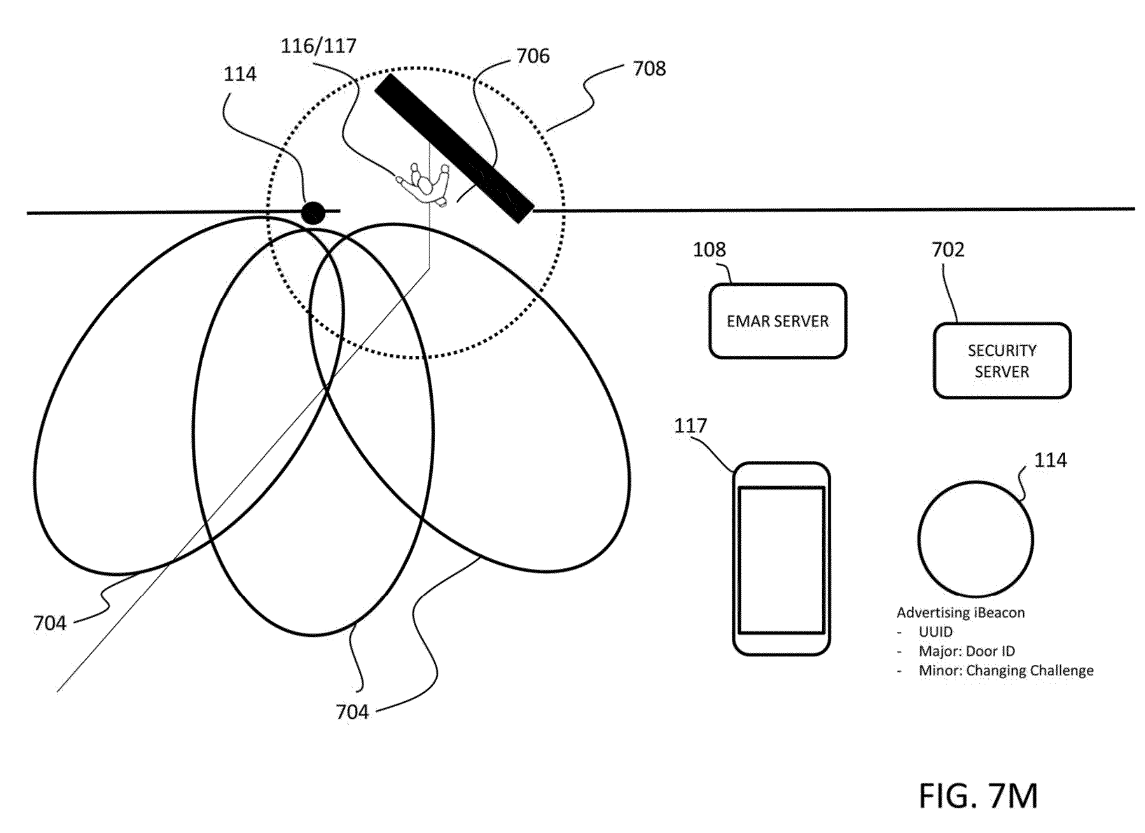

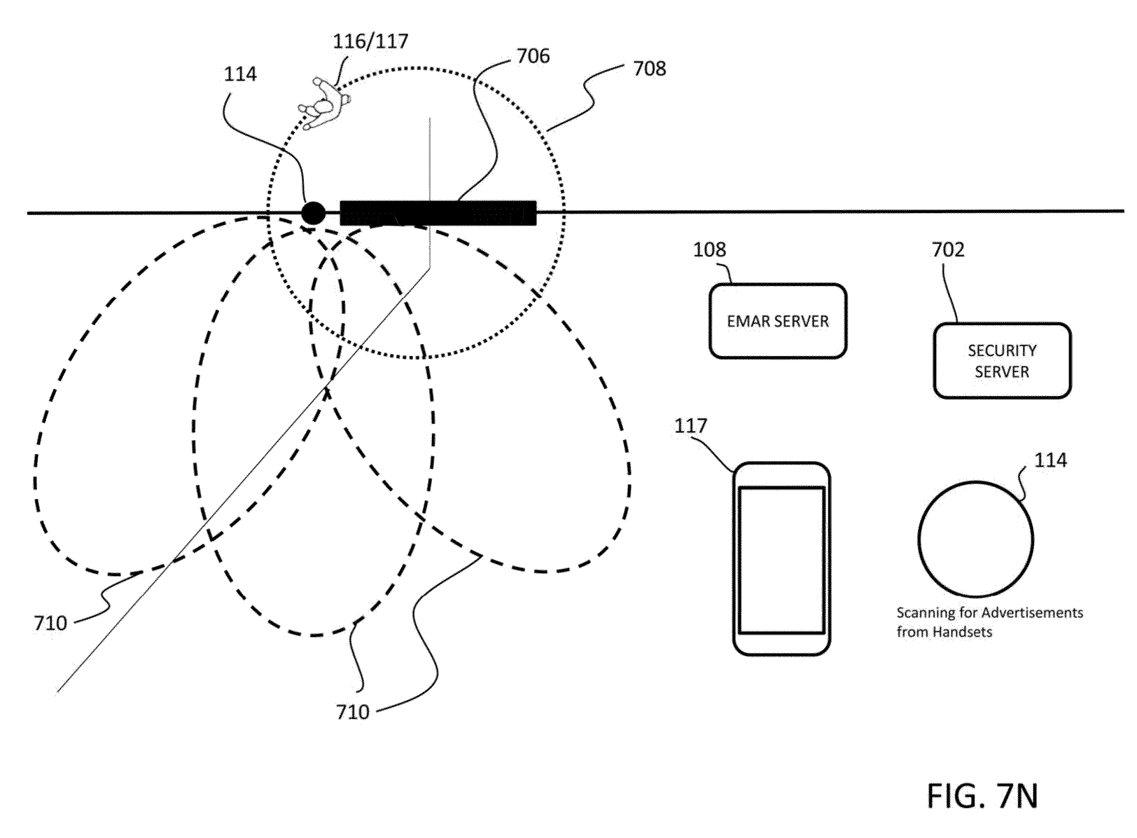

FIGS. 7A-7N are diagrams illustrating operation of an EMAR system that uses a handset (phone) 117 as a relay. In the illustrated scenario, an entity 1116 carries a device 117 and approaches a door 706 that is controlled by an EMAR system 100 and monitored by an EMAR unit 114. The EMAR unit 114 advertises: its universally unique identifier (UUID); an ID for door 706; and a door challenge. The EMAR unit 114 in one embodiment is an advertising iBeacon™, but embodiments are not so limited.). iBeacon™ is an indoor positioning system available from Apple Inc. iBeacon™ is a class of low-powered, low-cost transmitters that can notify nearby iOS devices of their presence. They can also be used by the Android™ operating system (limited to central-only). The iBeacon™ technology enables an iOS device or other hardware to send push notifications to iOS devices in close proximity. While iBeacon™ is used to describe embodiments of the invention, it is but an example and other comparable technologies can be used. The iBeacon™ uses Bluetooth™ low energy proximity sensing to transmit a universally unique identifier (UUID) picked up by a compatible app or operating system that can be turned into a physical location or trigger an action on the device.

Other components in the scenarios are one or more EMAR servers iOS and one or more security servers 702. Security servers 702, in this scenario are security servers for a building such as a commercial office building or an apartment building.

In FIG. 7A, the entity 116 and device 117 are approaching door 706. The shaded areas 704 represent the potential scanning area of the EMAR unit 114 for advertisements, but no scanning taking place. FIG. 7B shows areas 710 demarcated with dotted lines, which represent the EMAR unit 114 scanning for advertisements from handsets.

FIG. 7C shows entity 116 and device 117 reaching the boundary of area 704, causing device 117 to detect a beacon signal from EMAR unit 114. FIG. 7B shows that as a result of detecting the beacon signal from EMAR unit 114, an app (mobile application) wakes up in the background on device 117. Device 117 registers for location updates and starts advertising Bluetooth (BT (service). At the same time, EMAR unit 114 is scanning for advertisements from handsets. As entity 116 and device 117 continue to approach door 706 and EMAR. unit 114 (FIG. 7E), device 117 and the EMAR unit beacon connect to each other.

FIG. 7F shows the device 117 app sending a challenge-response message to the EMAR unit 114. As shown in FIG. 7G, The response is transmitted by the EMAR unit 114 to the EMAR server 108 via WiFi, but the embodiment is not so limited. The EMAR server 108 tests the response.

FIG. 7H shows the EMAR server 108 sending a “Yes/No” to the EMAR unit 114 beacon to indicate whether or not the response is authenticated. In an embodiment, the EMAR unit 114 indicates authentication success or failure with a green or red LED. The EMAR unit 114 continues to scan for advertisements.

In FIG. 7I, the device 117 app receives a “near” notification, and sends an “open” request to the EMAR unit 114 to ask that the door 706 be unlocked. The “near notification is received when device 117 enters the area of proximity marked 708.

FIG. 7J shows the entity 116 and the device 117 within area 708. The connection between device 117 and the EMAR unit 114 is dropped. The “open” request received by EMAR unit 114 is relayed to the EMAR server 108.

As the entity 116 and the device 117 continue to approach door 706 (FIG. 7K), the EMAR server sends an “open” request to the security server 708. The EMAR unit 114 may begin scanning for advertisements. In FIG. 7L, the security server 708 remotely unlocks the door 706. The EMAR server 108 sends a “done” signal to the EMAR unit 114 (also referred to in this description simply as “beacon”). The EMAR unit 114 receives the “done” signal and goes to a rest state. As shown in FIG. 7M, the door 706 opens to allow entity 116 to walk through. The door closes behind entity 116 and the EMAR unit 114 continues scanning for advertisements (FIG. 7N).

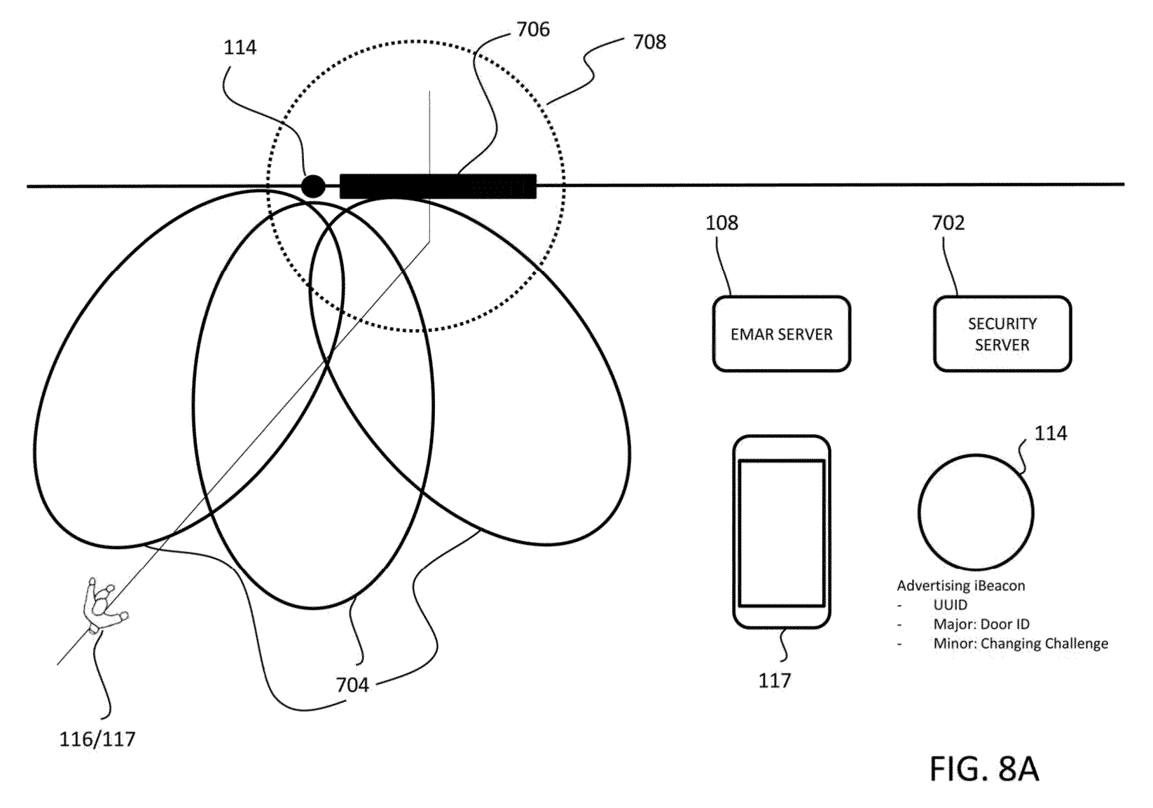

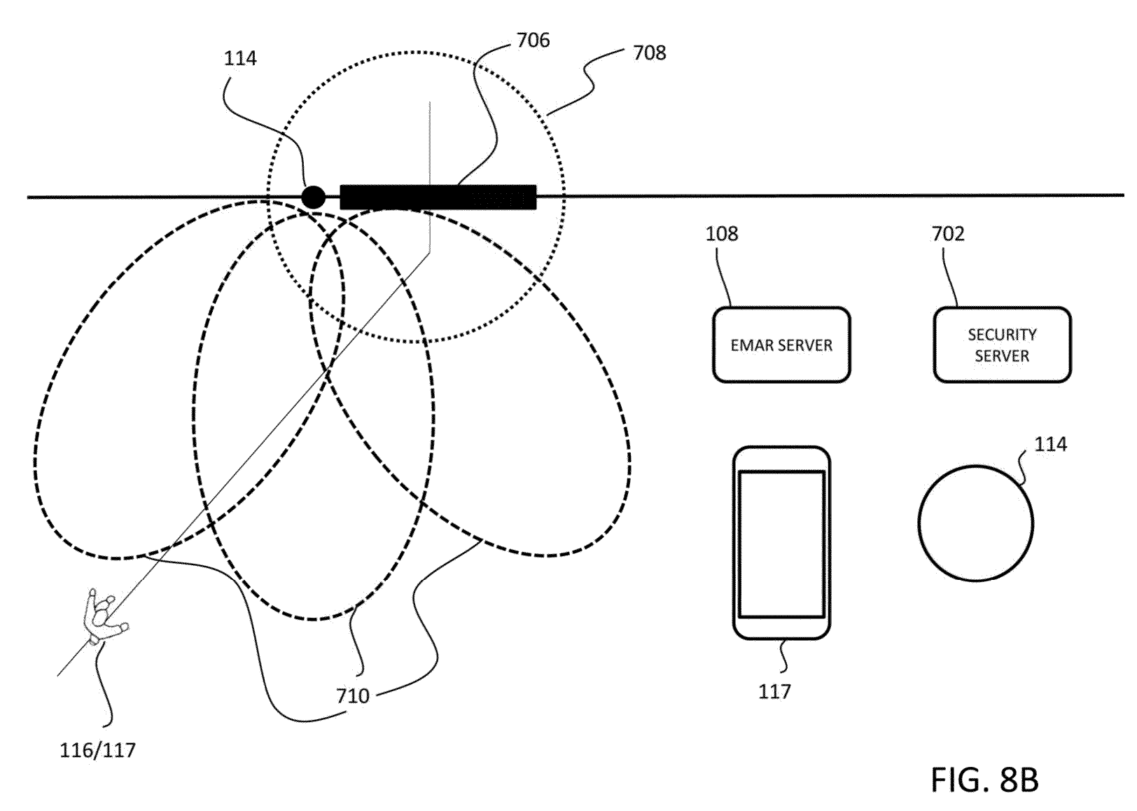

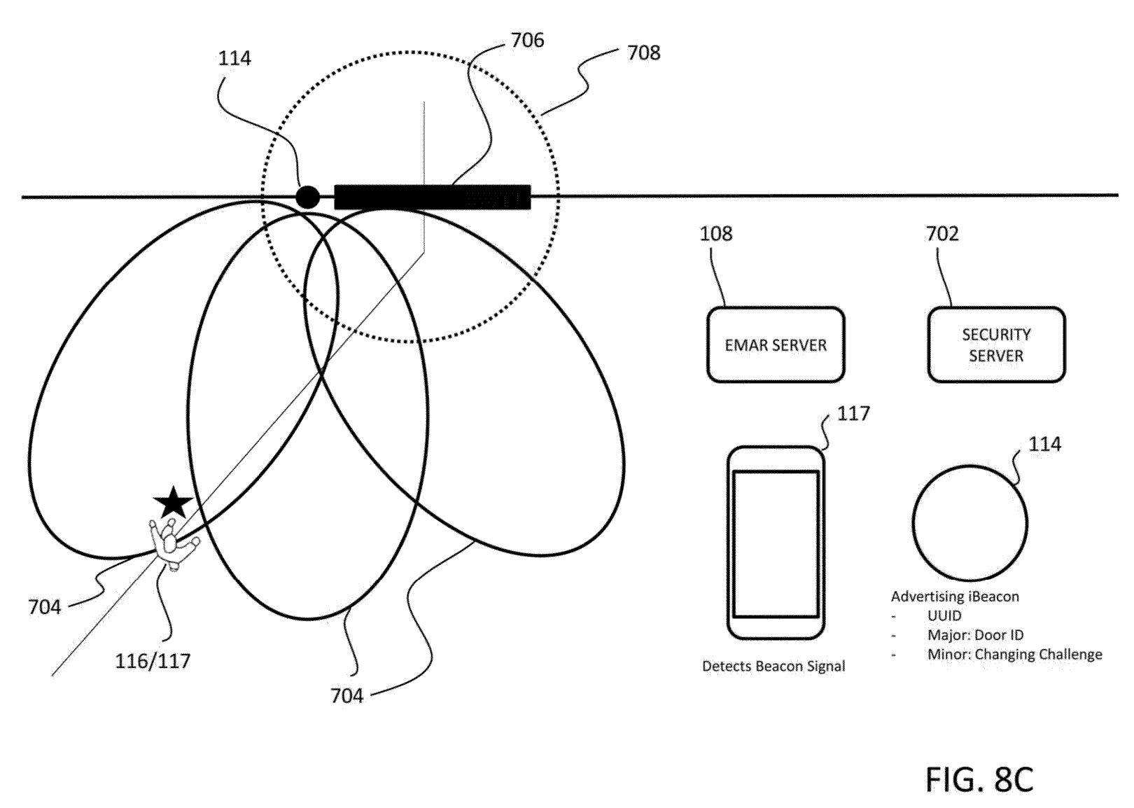

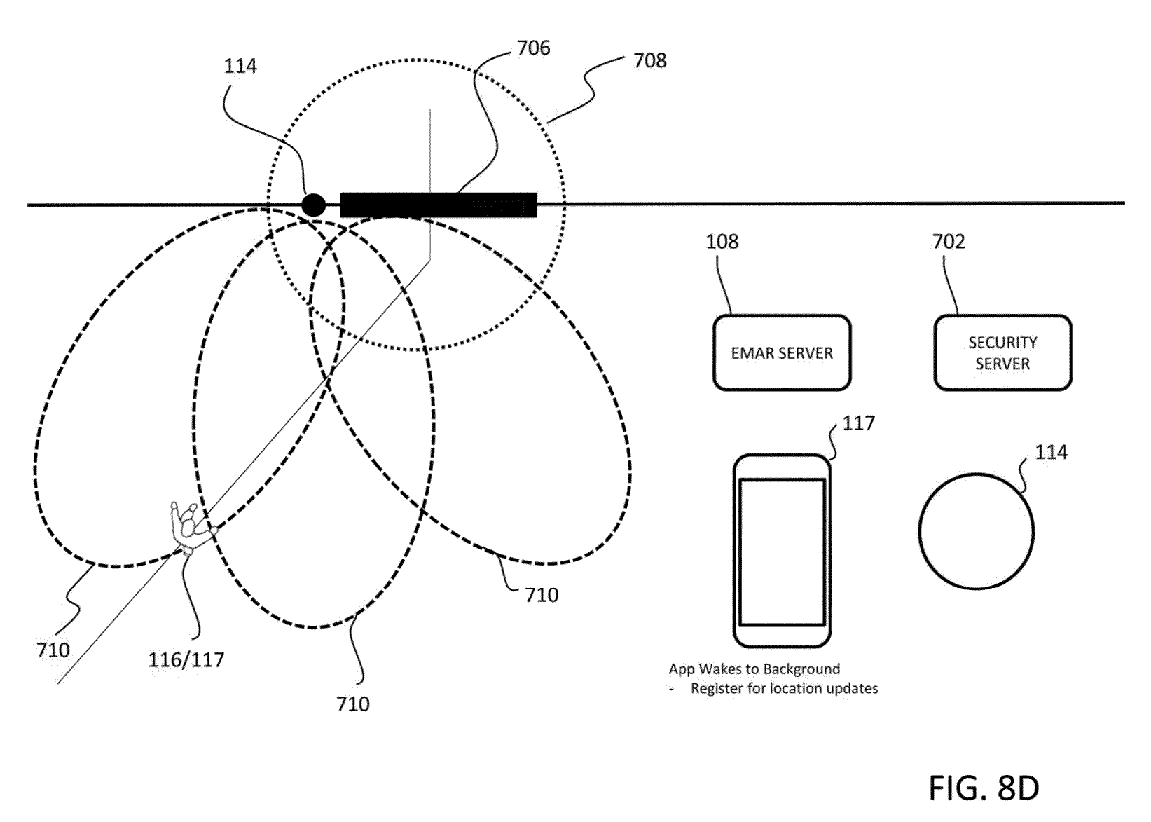

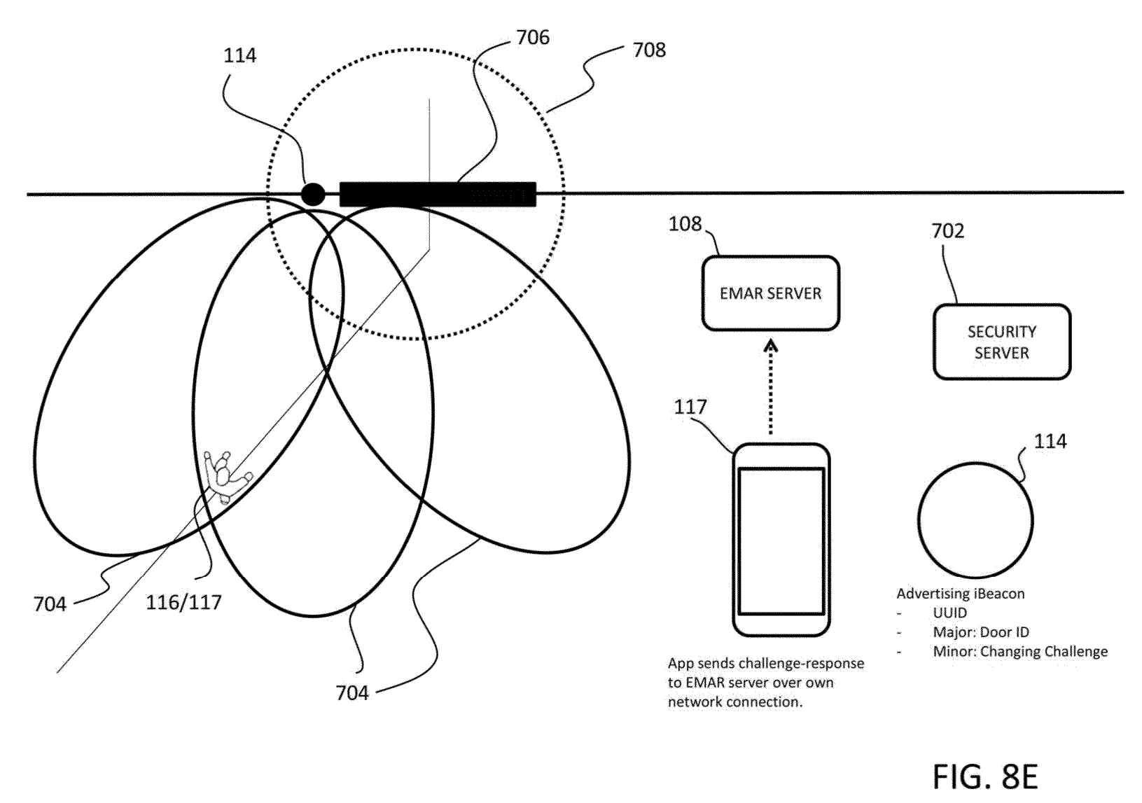

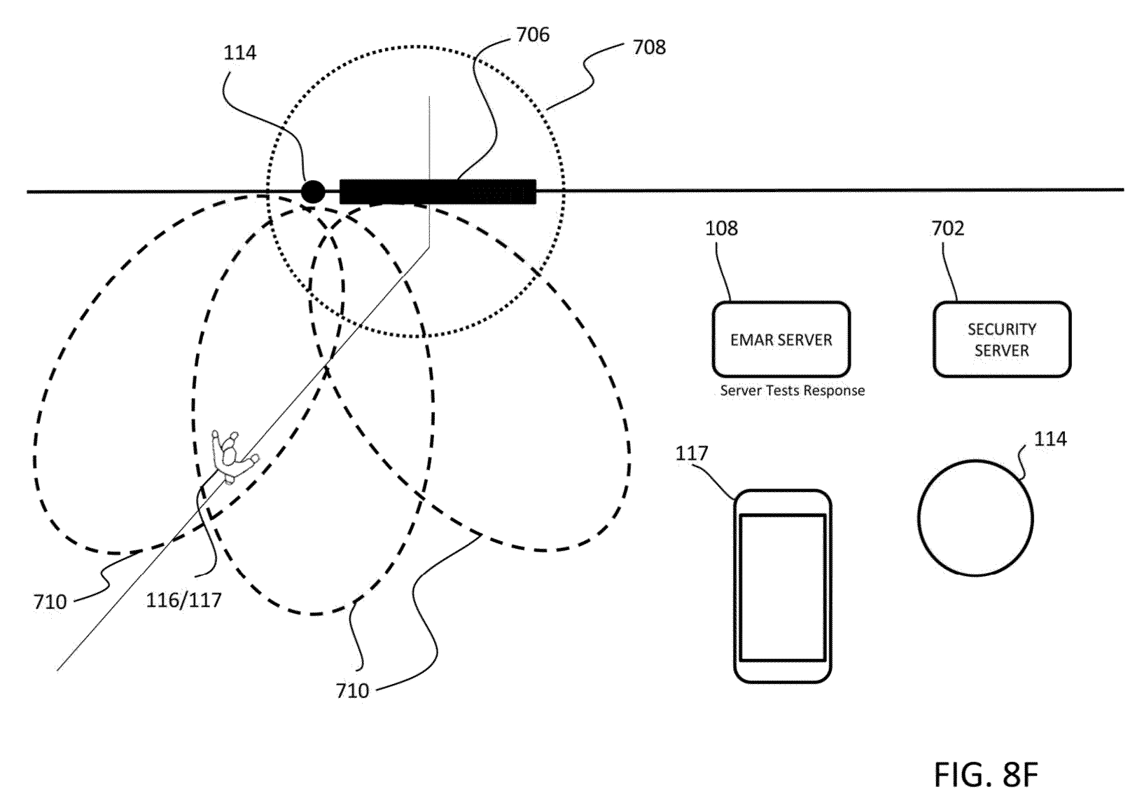

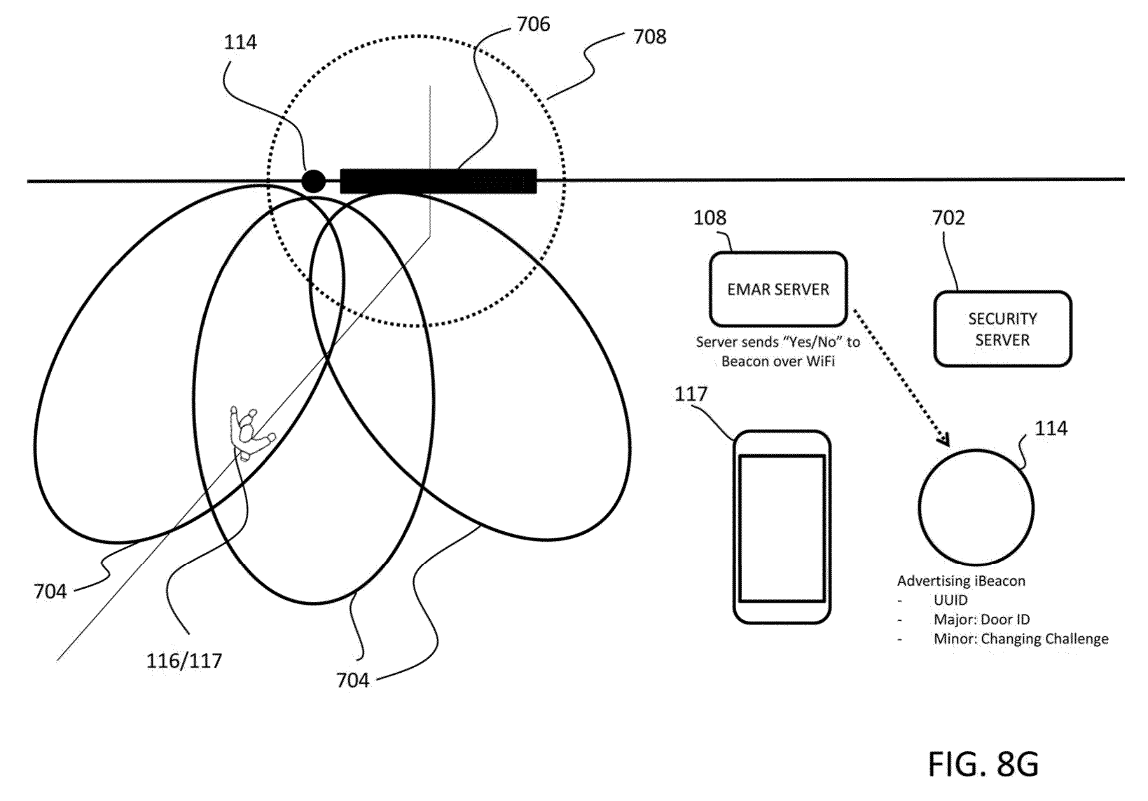

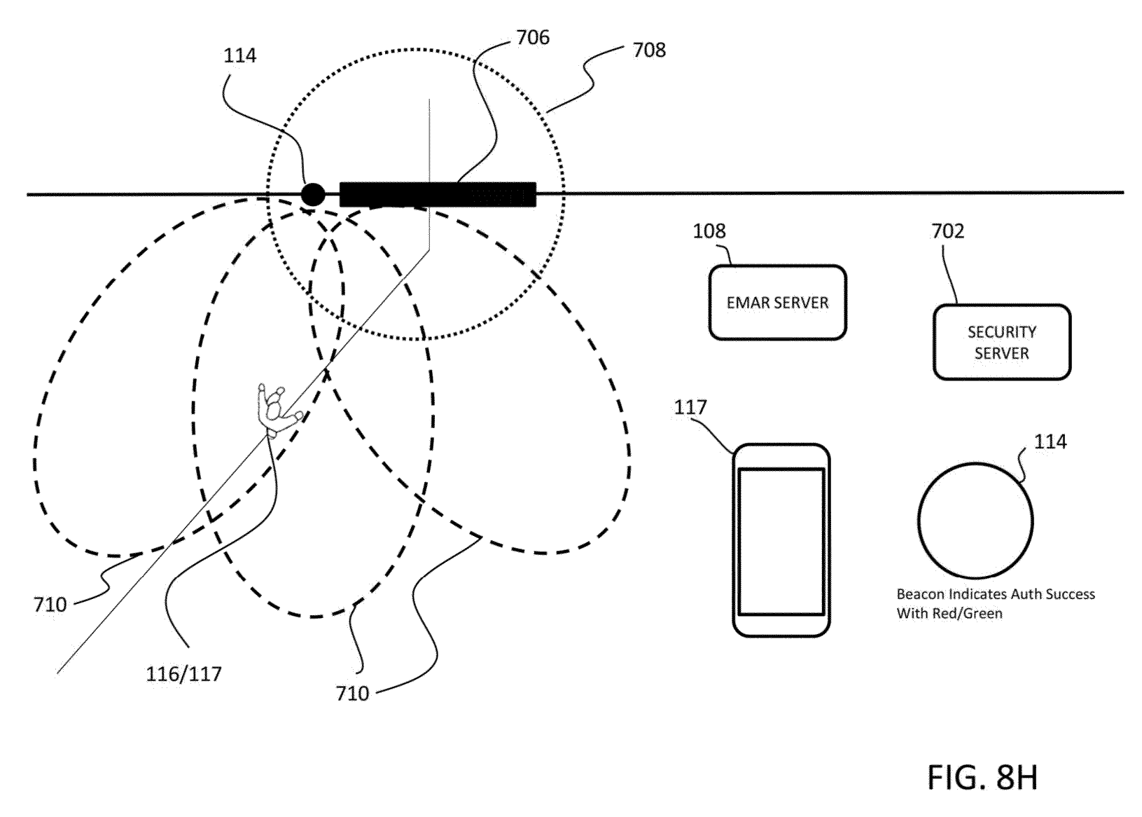

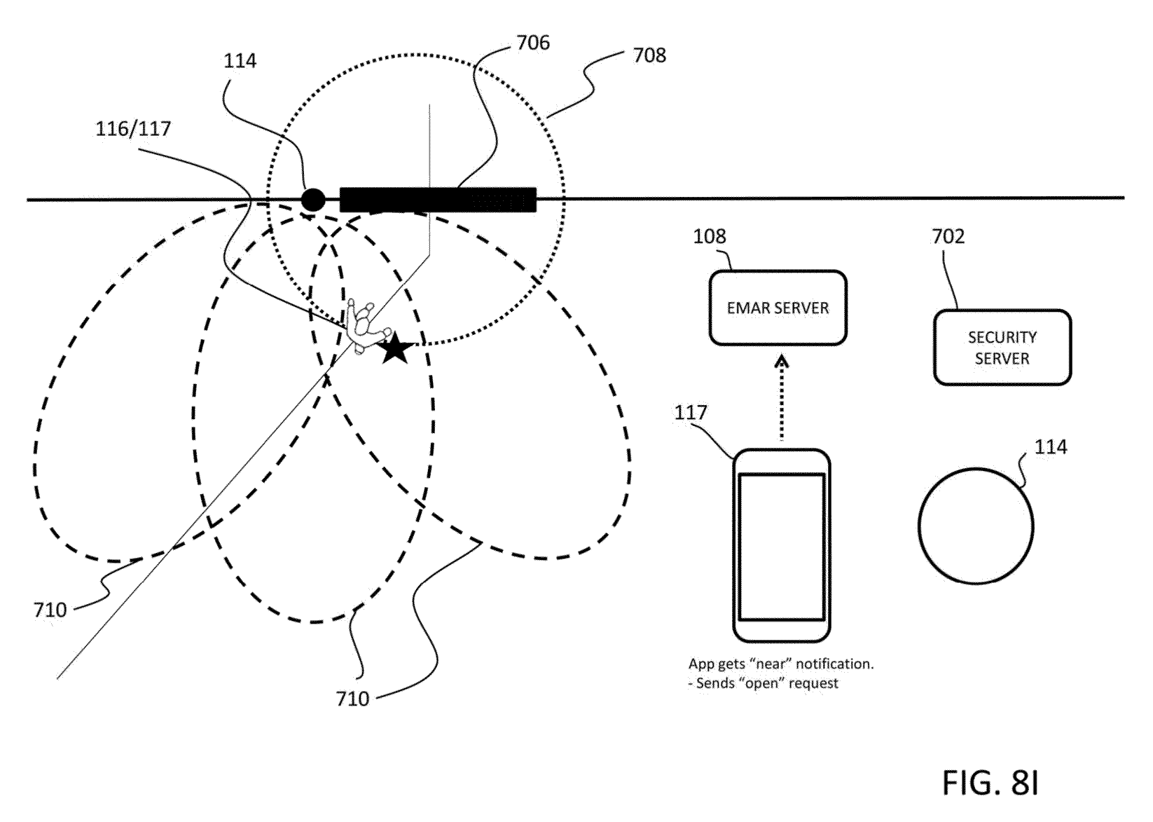

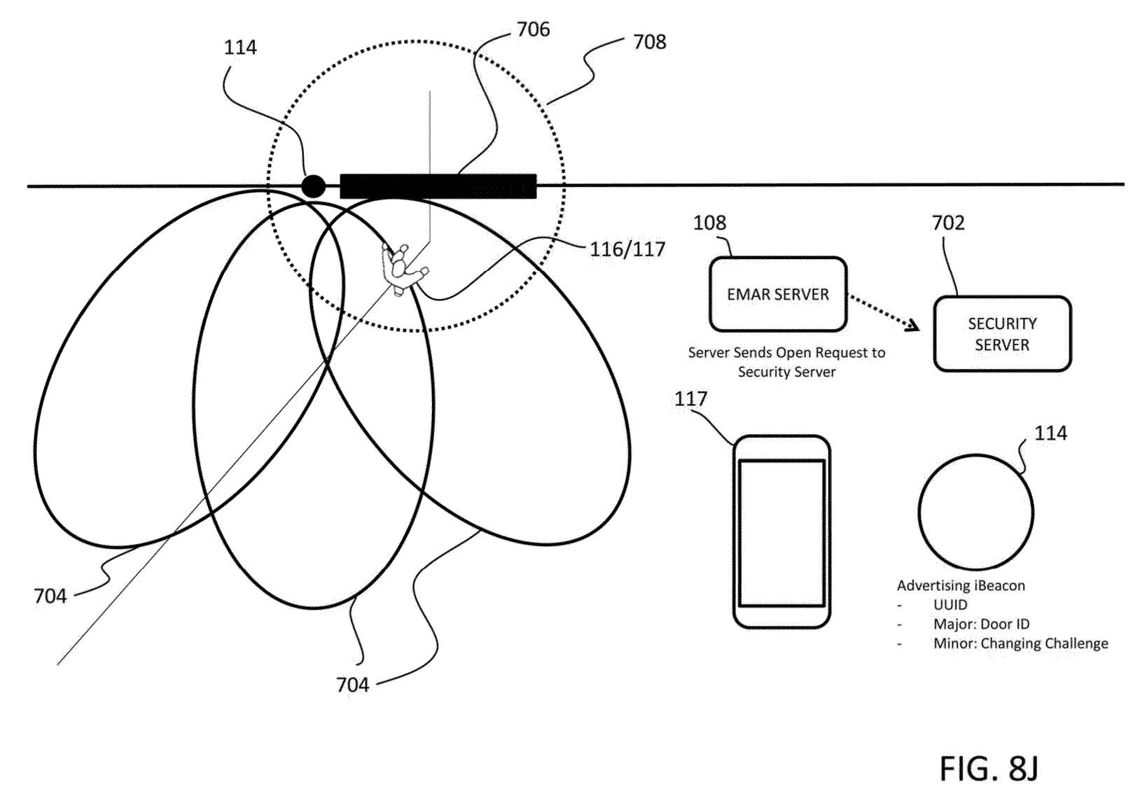

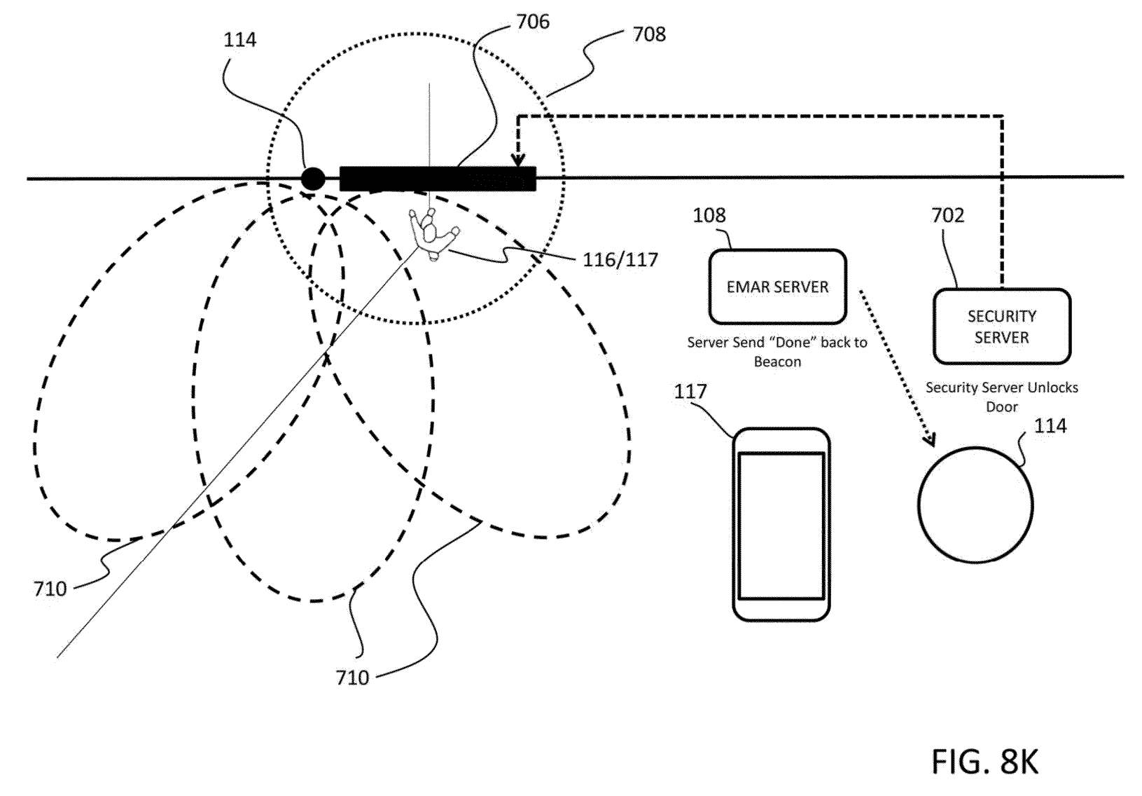

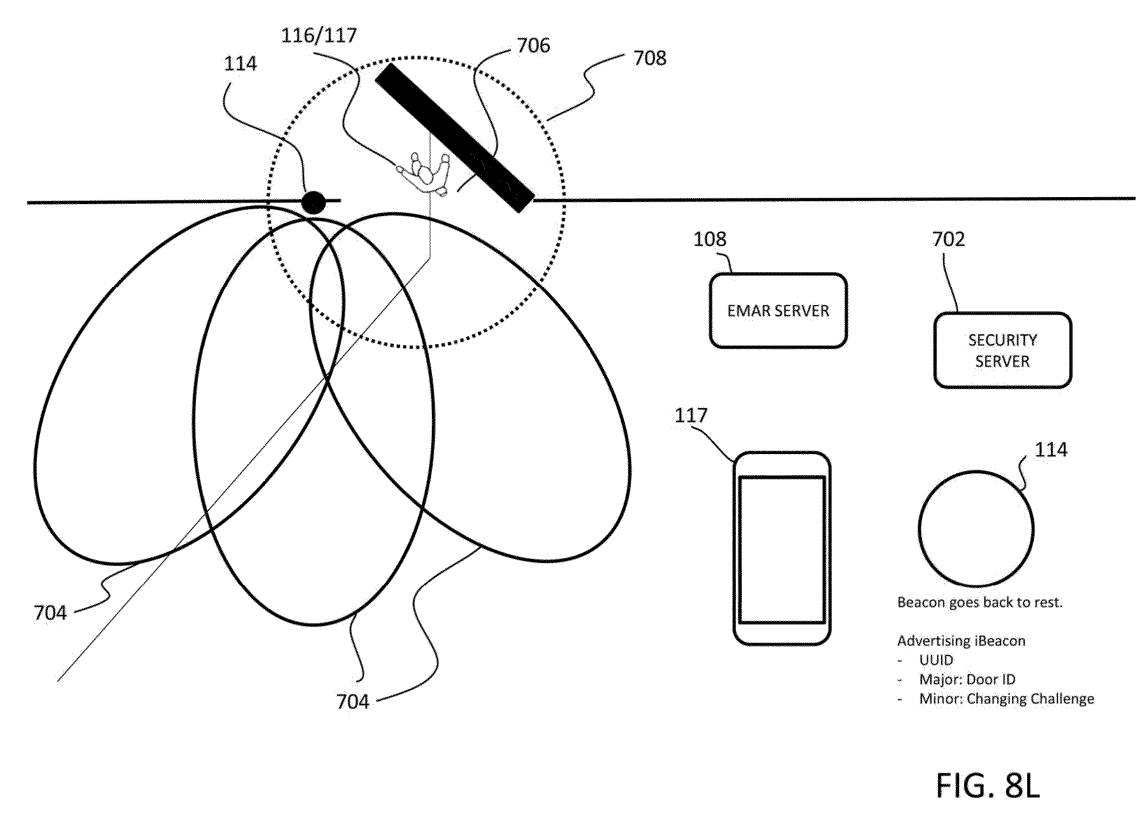

FIGS. 8A-8L are diagrams illustrating operation of an EMAR system according to an alternate embodiment in winch the device 117 has its own connection to the EMAR server 108 and does not require a relay from the EMAR unit 114.

in FIG. 8A, the entity 116 and device 117 are approaching door 706. The shaded areas 704 represent the potential scanning area of the EMAR unit 114 for advertisements, but no scanning taking place. FIG. 8B shows areas 710 demarcated with dotted lines, which represent the EMAR unit 114 scanning for advertisements from handsets.

FIG. 8C shows entity 116 and device 117 reaching the boundary of area 704, causing device 117 to detect a beacon signal from EMAR unit 114. FIG. 8D shows that as a result of detecting the beacon signal from EMAR unit 114, an app (mobile application) wakes up in the background on device 117. Device 117 registers for location updates. At the same time, EMAR unit 114 is scanning for advertisements from handsets.

In FIG. 8E, the mobile app on the device 117 sends a challenge-response to the EMAR unit 1-8 over its own network connection.

FIG. 8F shows the EMAR server 108 testing the response. FIG. 8G shows the EMAR server 108 sending a “Yes/No” to the EMAR unit 114 beacon to indicate whether or not the response is authenticated. In an embodiment, the EMAR unit 114 indicates authentication success or failure with a green or red LED (FIG. 8H). The EMAR unit 114 continues to scan for advertisements.

In FIG. 8I, the device 117 app receives a “near” notification, and sends an “open” request to the EMAR unit 114 to ask that the door 706 be unlocked. The “near notification is received when device 117 enters the area of proximity marked 708.

FIG. 8J shows the entity 116 and the device 117 within area 708. An “open” request is sent by the EMAR server 108 to the security server 702.

In FIG. 8K, the security server 708 remotely unlocks the door 706. The EMAR server 108 sends a “done” signal to the EMAR unit 114 (also referred to in this description simply as “beacon”).

As shown in FIG. 8L, the door 706 opens to allow entity 116 to walk through. The EMAR unit 114 goes to a rest state.

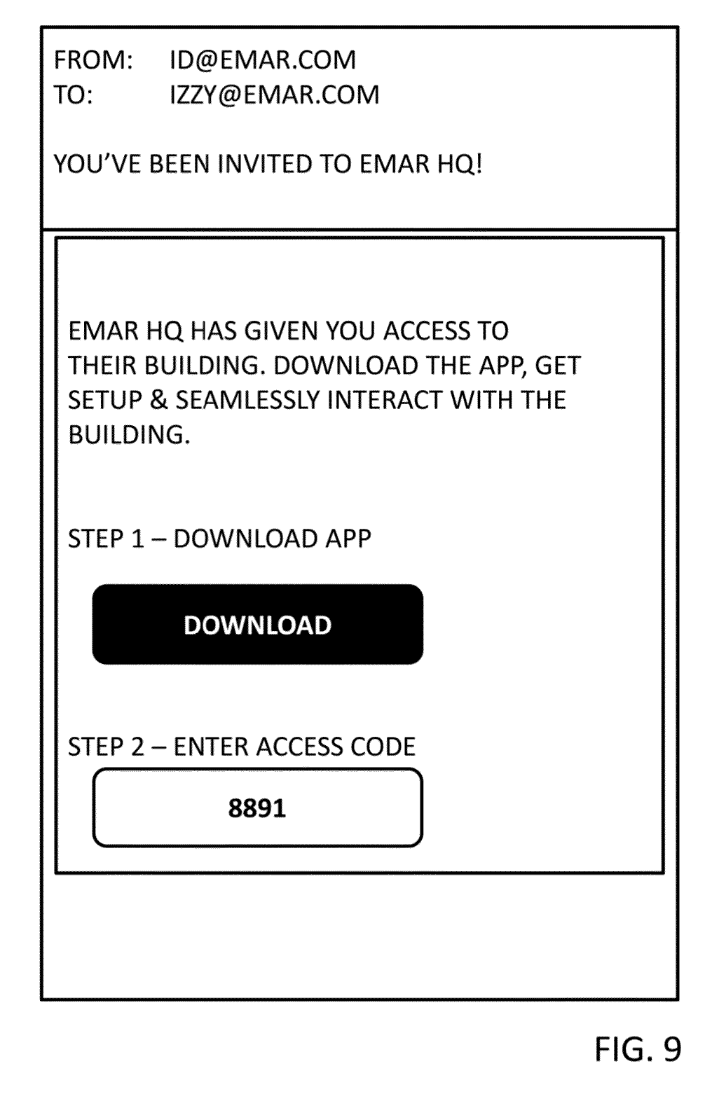

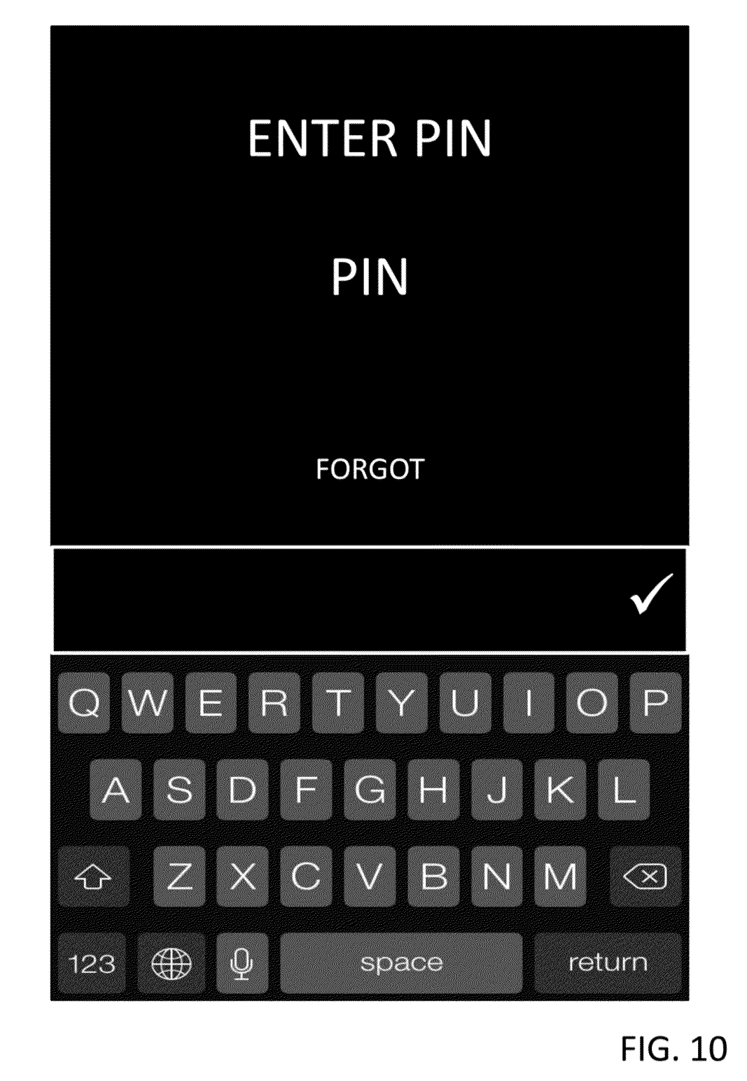

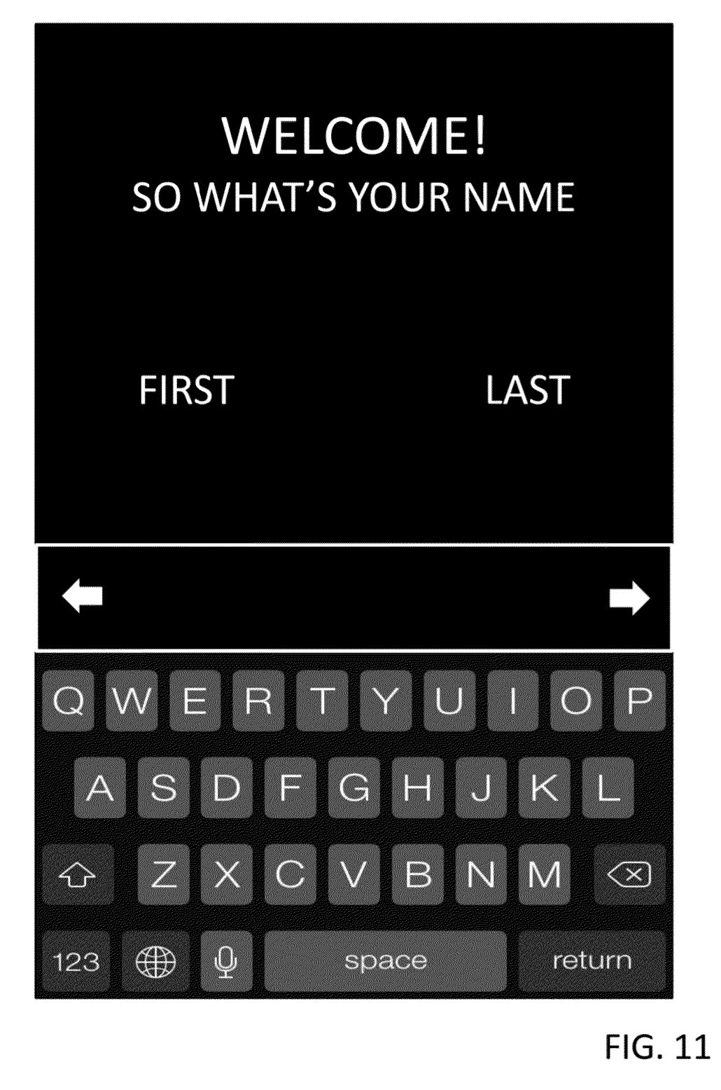

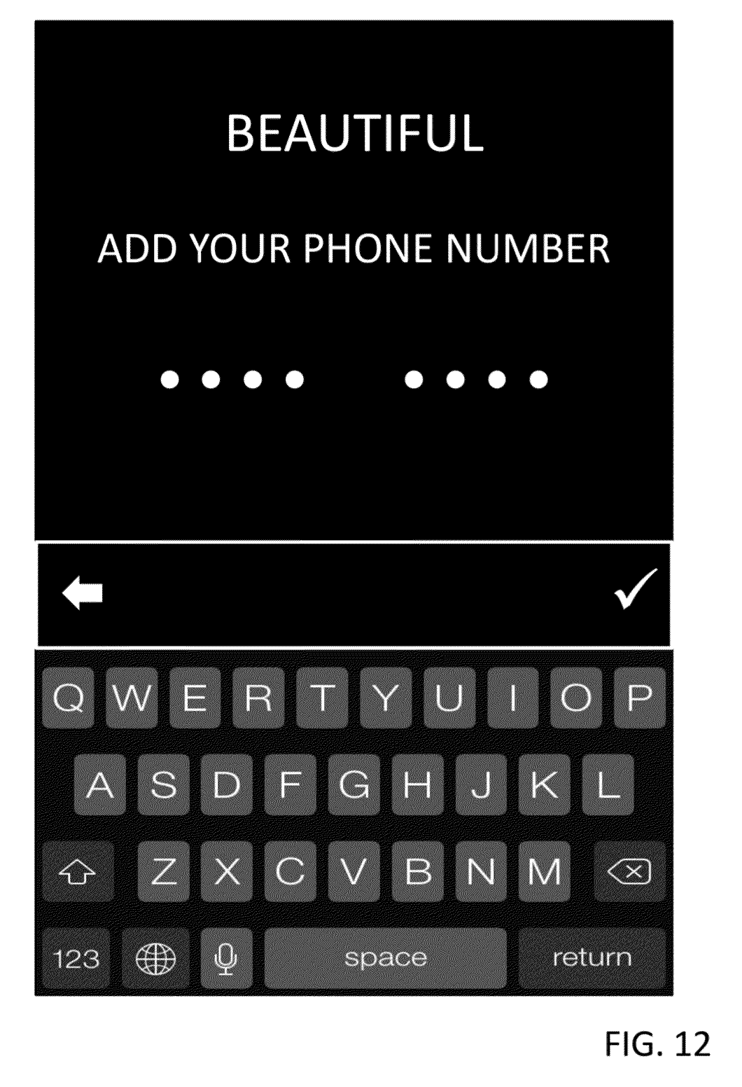

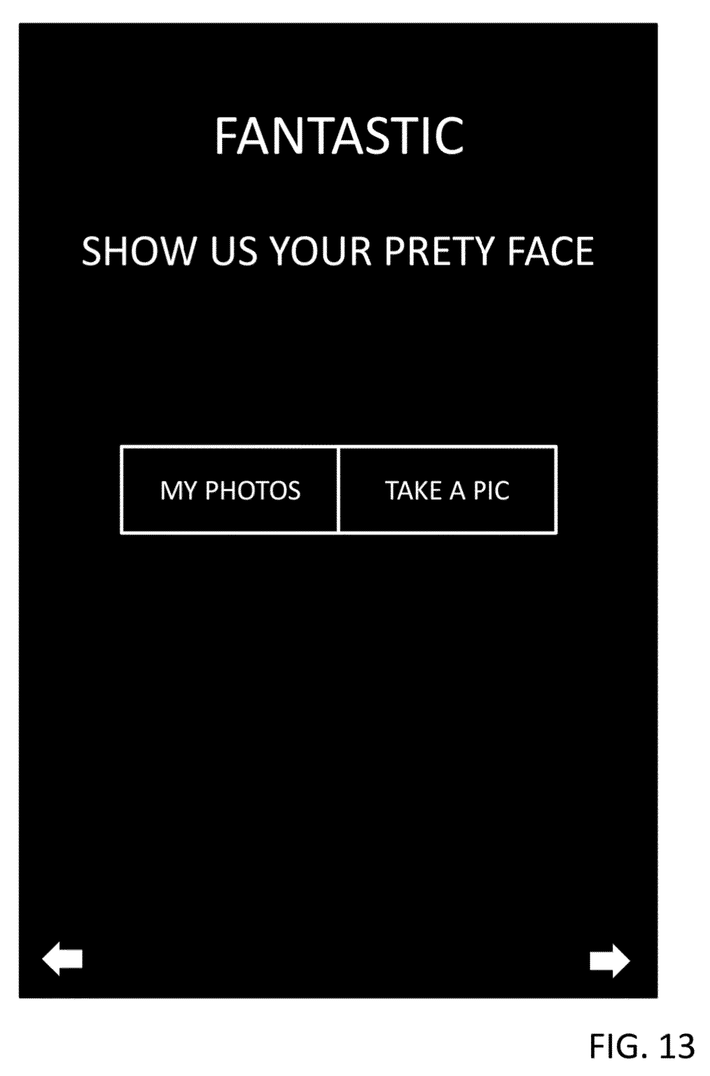

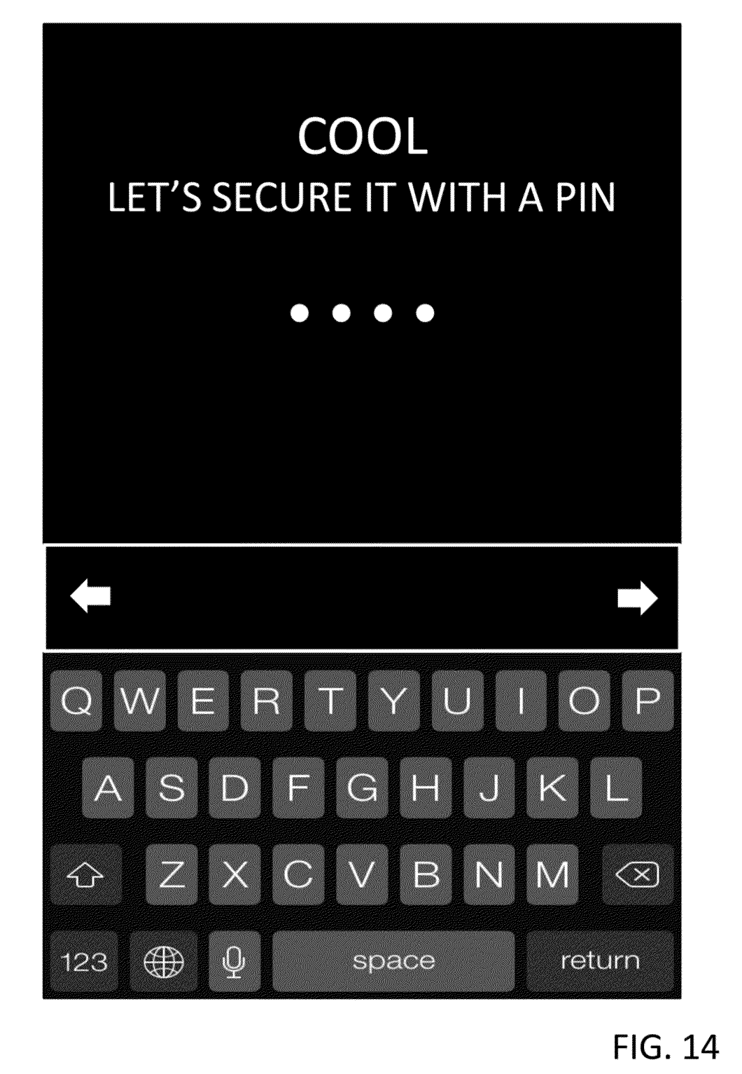

FIGS. 9-17 show example user interface screens for an EMAR mobile app on a device 117. Specifically, the screens are encountered during a set up process by a user (entity) who is going to be allowed to access a building in accordance with the descriptions above. Initial screens (not shown) inform the user that a set up process is starting. The user is asked to turn on Bluetooth on the device, and to enter an access code. The access code may be provided (for example by an administrator of the building) by another communication method. The user is requested to enter an email address. Then, FIG. 9 is an invitation screen that informs the user they have been given access to the building called “EMAR HQ”. As a first step the user clicks to download the mobile app. Next the access code is entered. FIG. 10 shows a request for a PIN, and a place to click to recover a forgotten PIN. The screens of FIG. 11, FIG. 12, and FIG. 13 request the user's first and last name, the user's phone number, and the user picture. The PIN is entered to secure the information (FIG. 14).

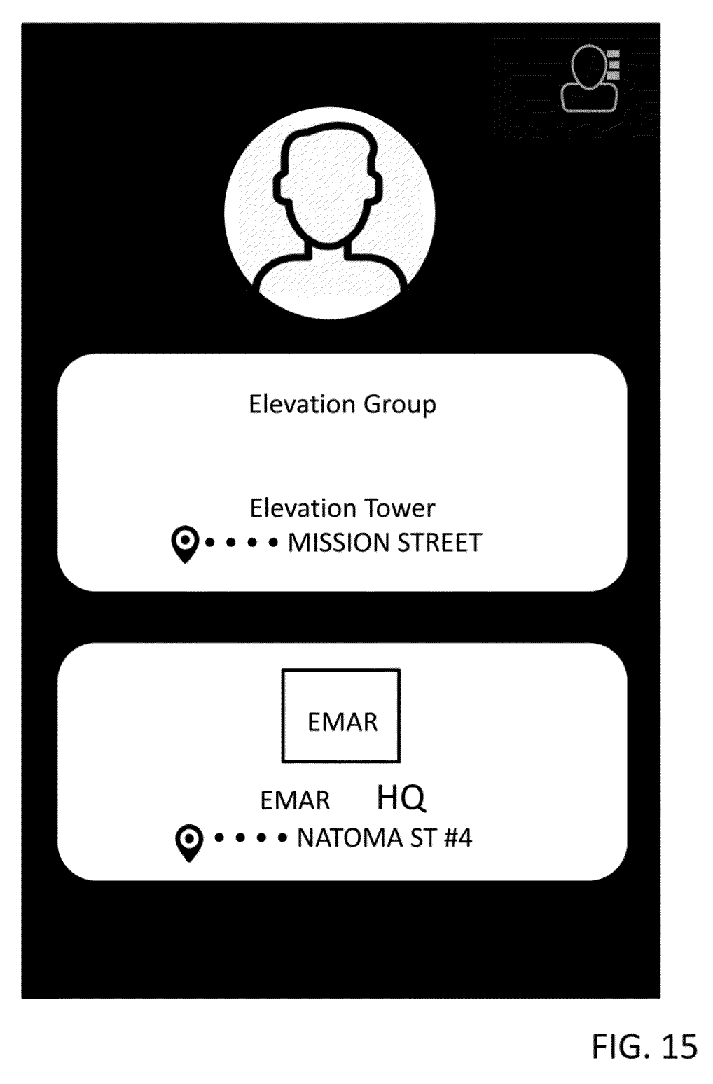

The screen of FIG. 15 show the user's photo above the buildings the user has been given access to. In this case, the user previously has access to Elevation Tower, and now also has access to EMAR HQ.

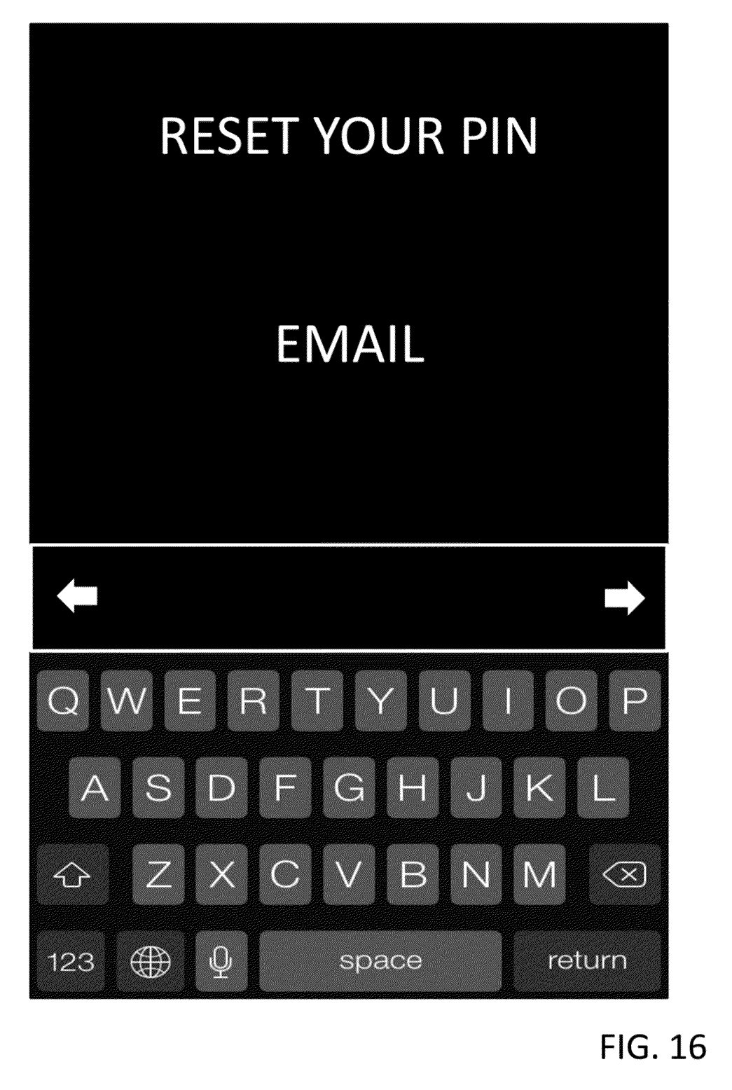

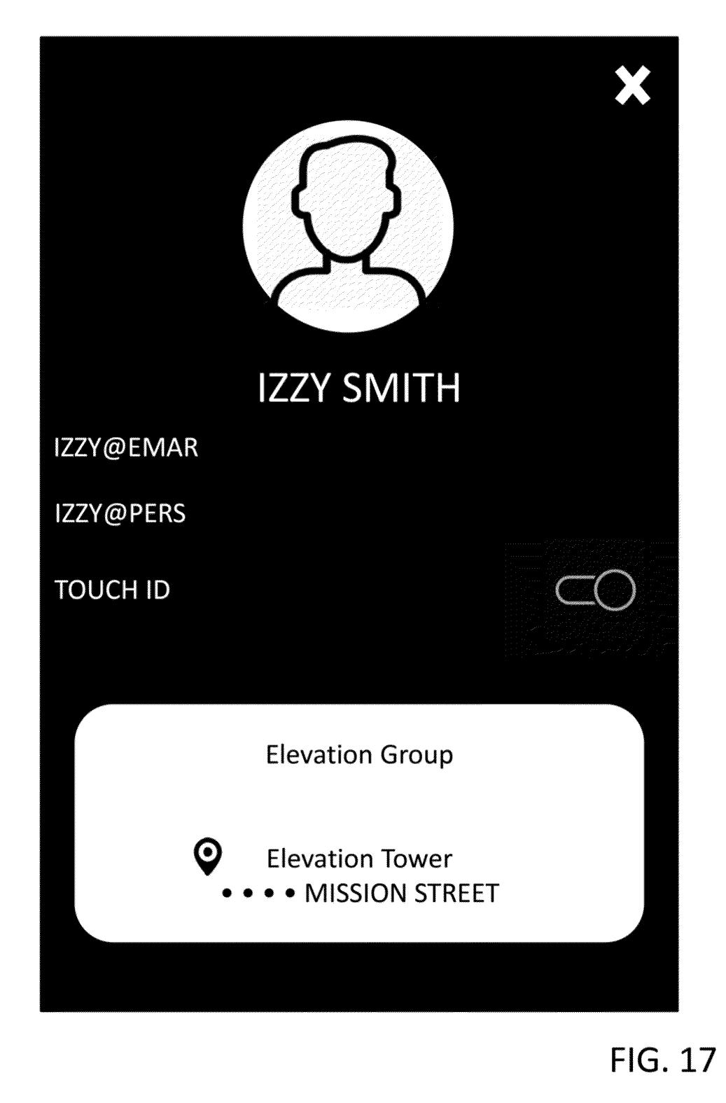

The FIG. 16 screen allows the user to reset the PIN. FIG. 17 shows the user information for the Elevation Tower building, including one or more email addresses and a place to turn touch ID on or off.

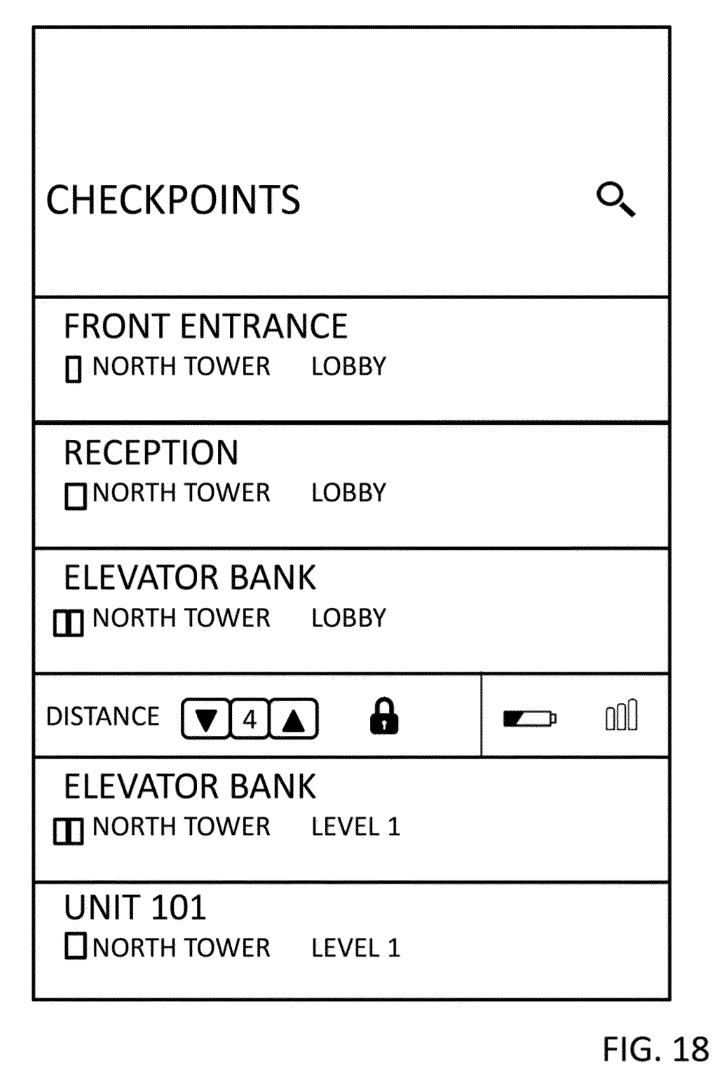

FIG. 18 is a screen shot from an administrator application. This shows the location of EMAR units (referred to here as checkpoints) within a building. The north tower lobby of the building includes checkpoints at the front entrance, at reception, and at the elevator bank. When the elevator bank is selected, it is possible to observe the battery level for the EMAR unit located there. It is also possible to change the distance at which the detection of a device 117 by an EMAR unit 114 occurs. An authorized person can only gain access to this application and make inputs to the application after being authenticated by entering one or more of a password, a text identifier (such as an email address) and a biometric identifier.

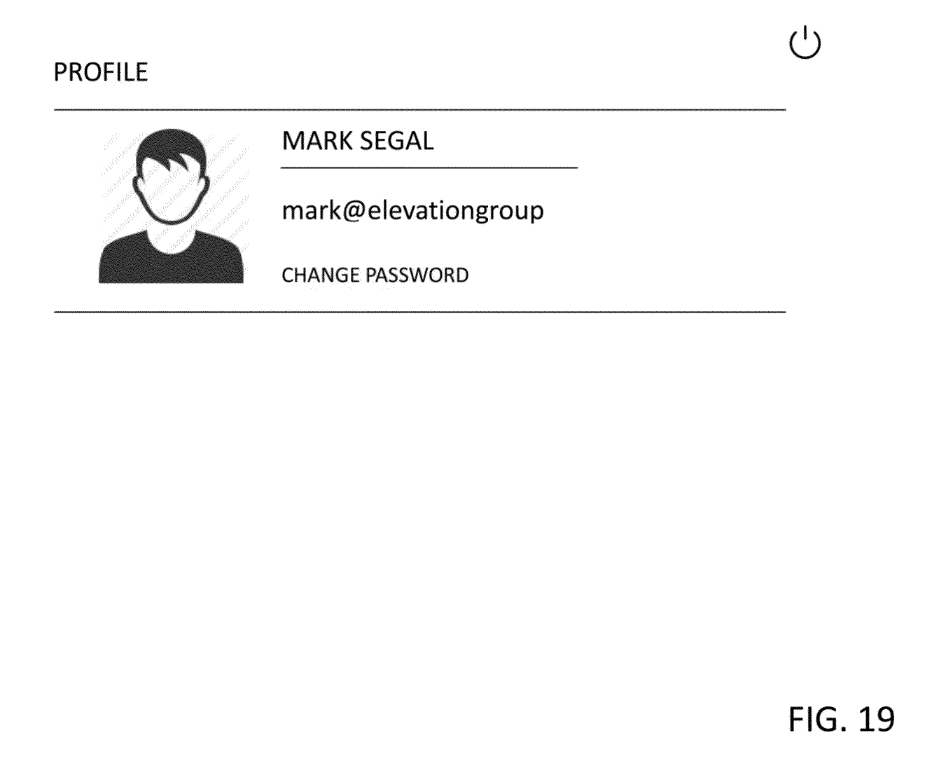

FIGS. 19-34 are screen shots of an administrative application or “dashboard” that can be used by a building administrator to manage an EMAR system. Analytic data is also available through the dashboard.

FIG. 19 is a profile page showing an administrator named Mark. All of the dashboard views are from Mark's account. Mark has a team that he can invite to the dashboard so that they can see analytics and manage selected functions or aspects that they are given access to. A team can include many roles, including but not limited to reception, maintenance, security, portfolio management, analysis, and so on.

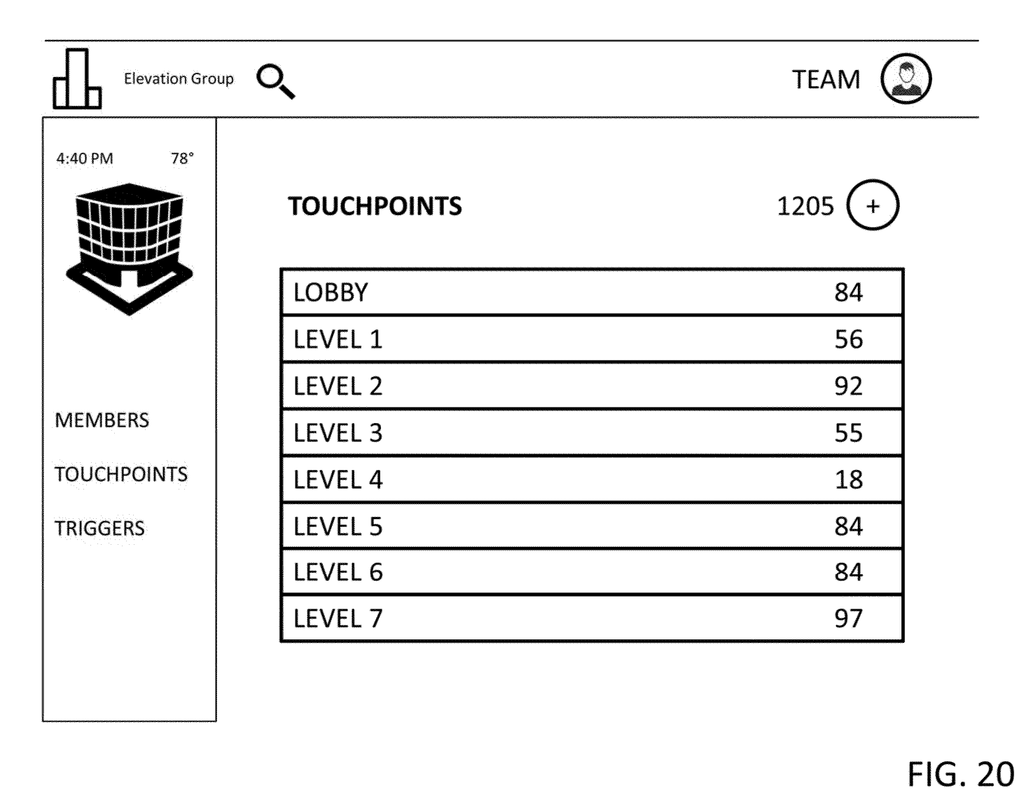

FIG. 20 shows a list of touch-points by floor. Touchpoints are locations where EMAR units (beacons) are placed. “Lobby” is a touchpoint group because several EMAR units are located in the lobby.

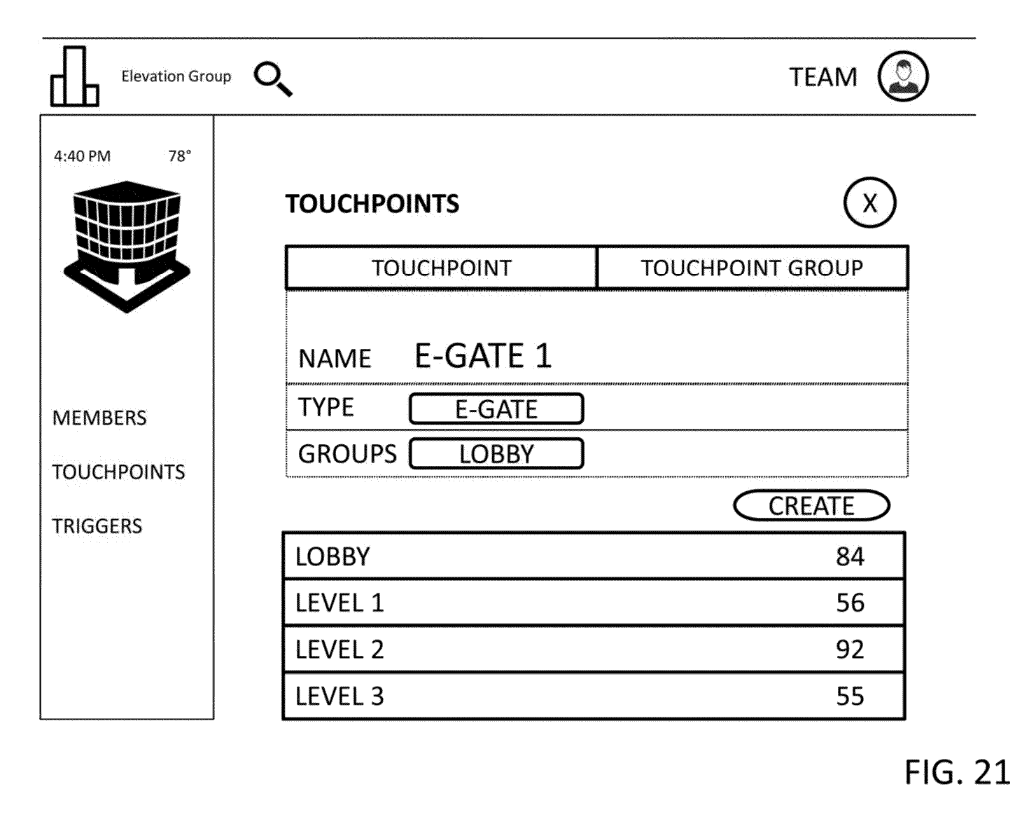

FIG. 21 is a screen where touchpoints can be created. A new touchpoint is given the name “E-GATE 1” and it is given type E-GATE and placed in group “LOBBY.

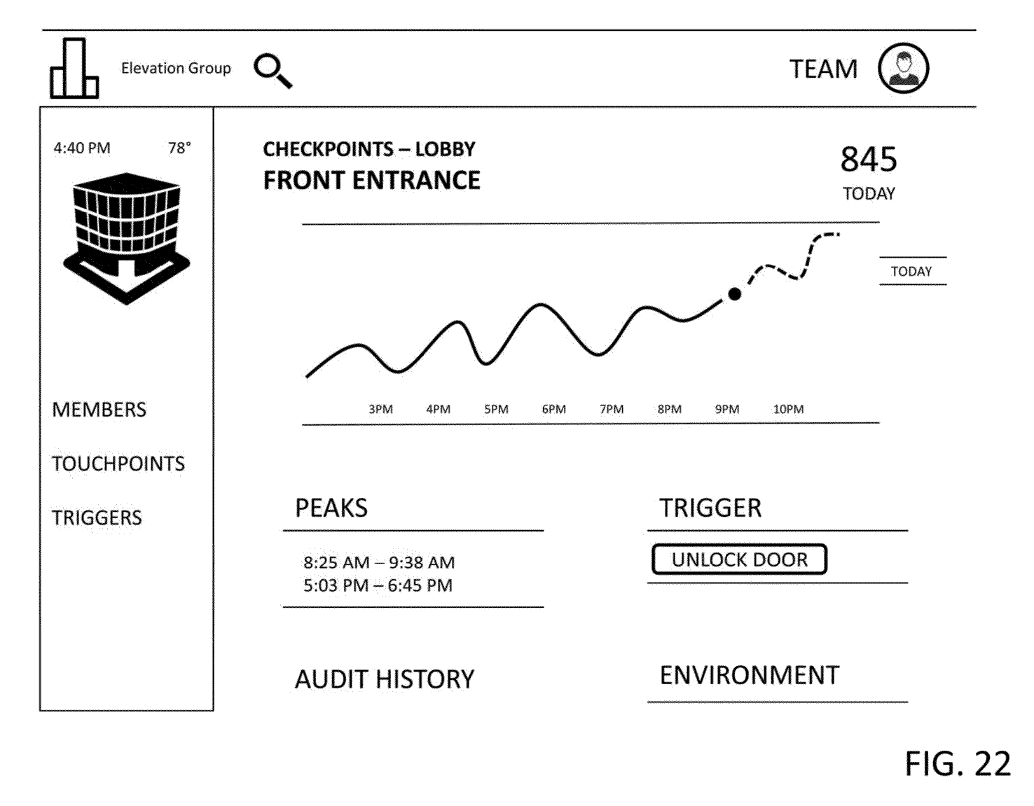

FIG. 22 is a screen showing a touchpoint profile. The touchpoint “FRONT ENTRANCE” is chosen and its usage plot for today is shown. Peak usage times are recorded, as are environmental factors such as temperature and humidity, A “trigger” is an action to be taken at this touchpoint based on a member reaching the touchpoint. Here is the action is “unlock door”. As another example, if the touchpoint were “ELEVATOR”, a trigger would be “call elevator”.

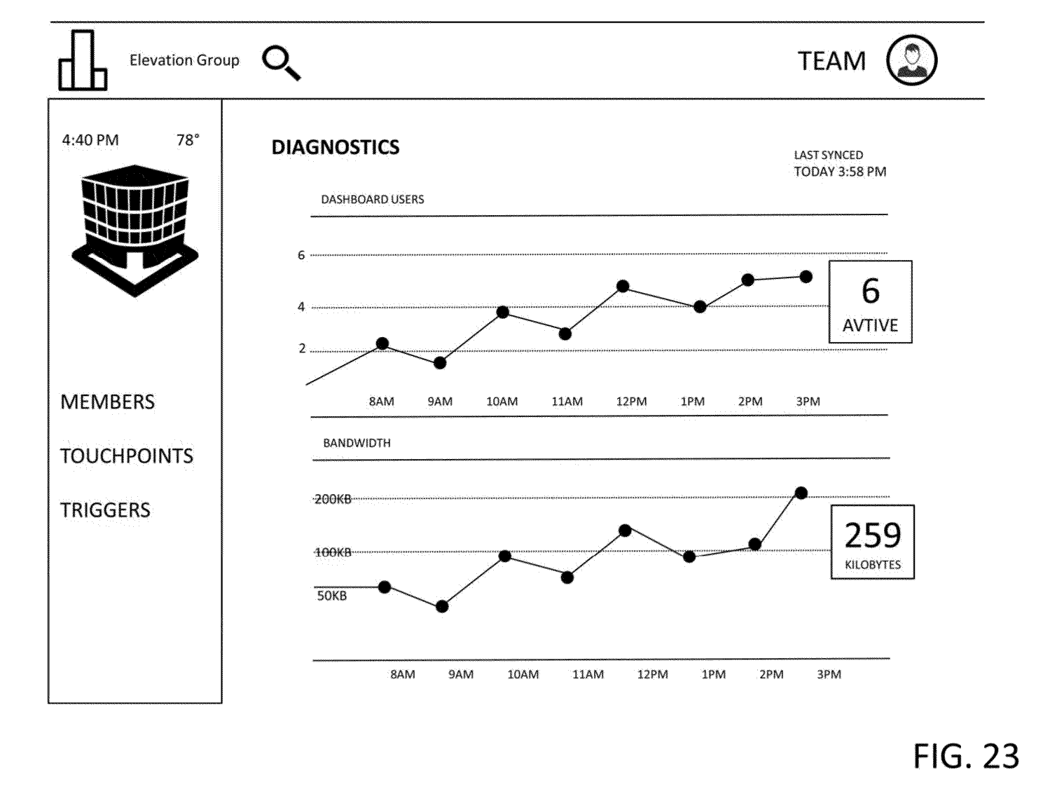

FIG. 23 is a diagnostics screen that shows the number of users active over the course of the day. It also shows bandwidth of the system over the day.

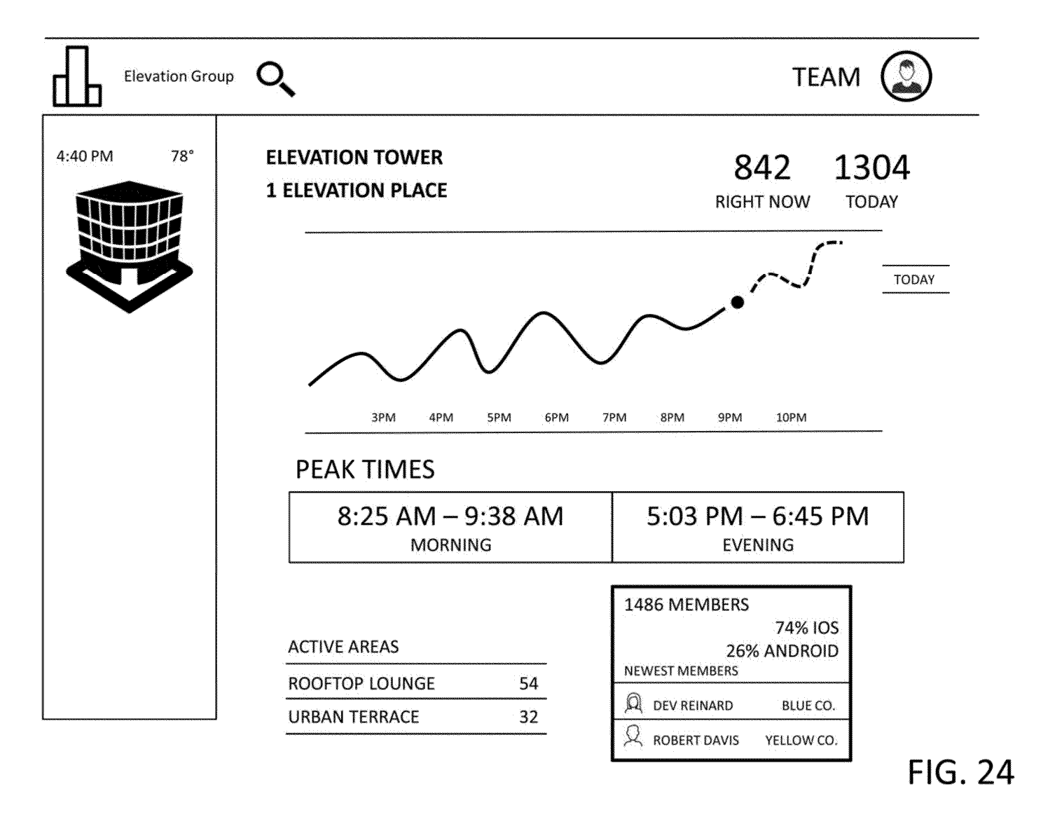

FIG. 24 is an activity screen that shows the number of users at the present time, as well as for the current day. It also displays a plot of activity levels over the day, as well as stating the peak usage times for morning and evening, and active areas. The total number of members is shown, as well as the percentage using iOS and the percentage using Android. The two newest members are shown.

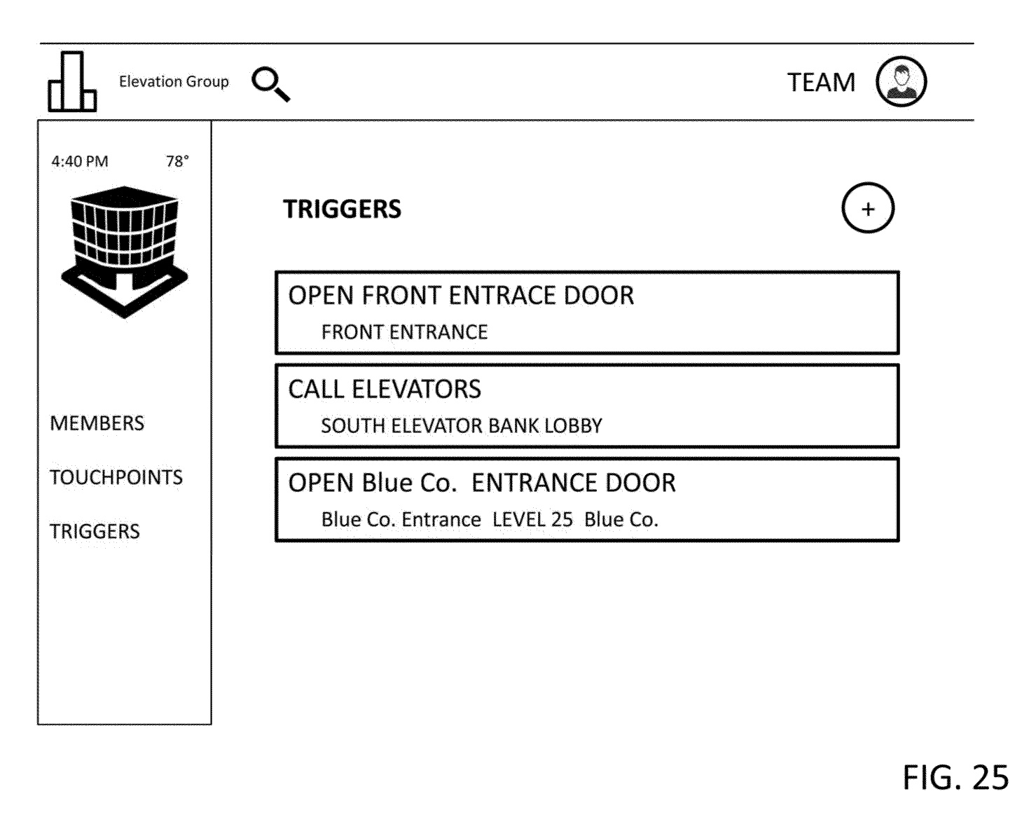

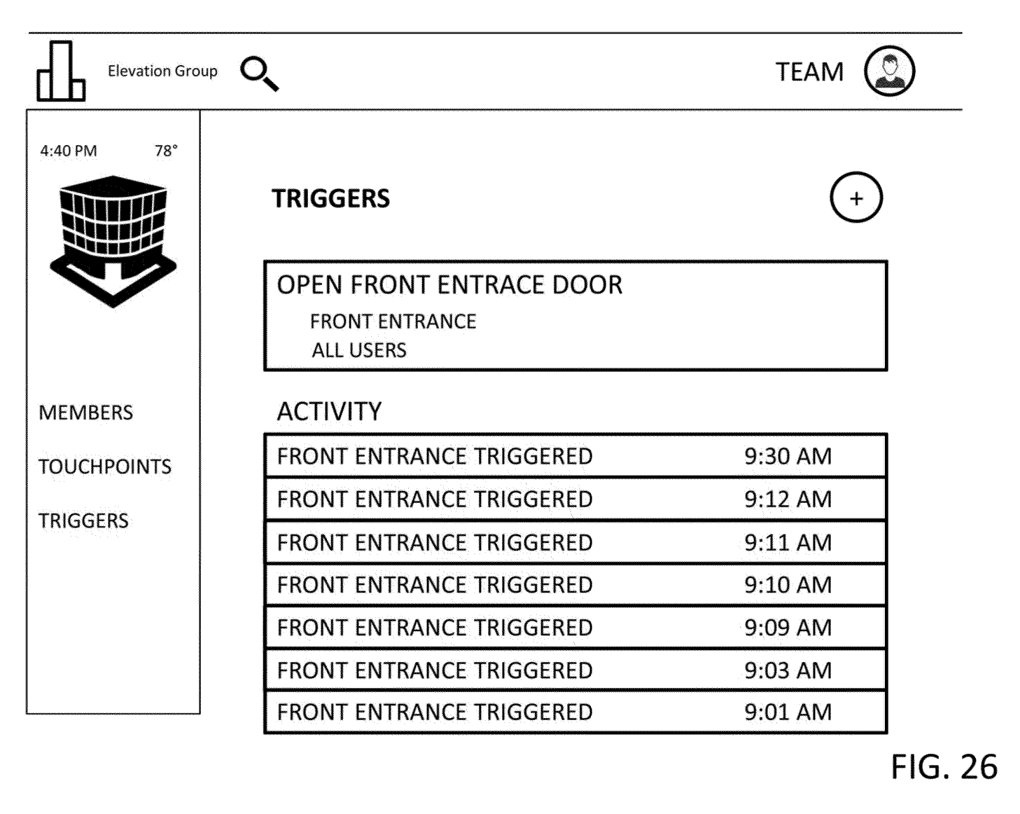

FIG. 25 lists triggers by name (the name here is descriptive of the function performed) and the touchpoint affected. FIG. 26 shows a trigger profile. The trigger is “OPEN DOOR” and the touch point is front entrance. All users can open the front door. An activity log is shown that lists times the front door was opened.

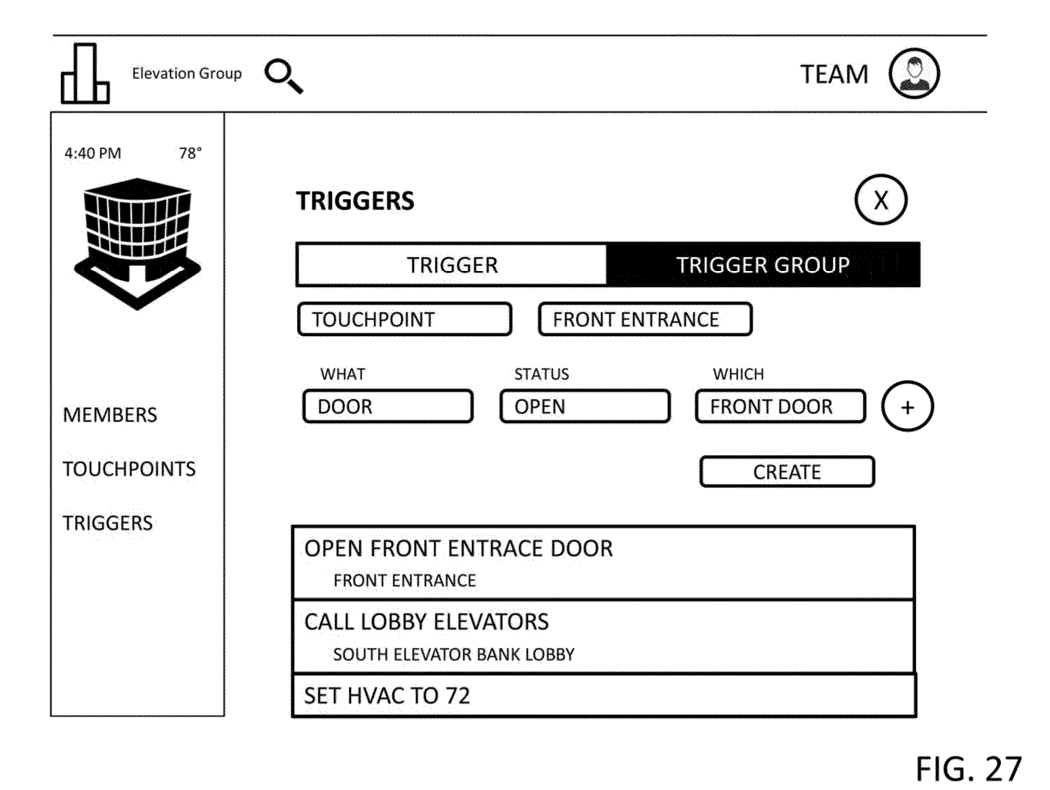

FIG. 27 shows a screen for creating a trigger. A touchpoint is chosen “front entrance”. An object to be acted on is chosen “door”, the status “open”, and which door, for example “front door”.

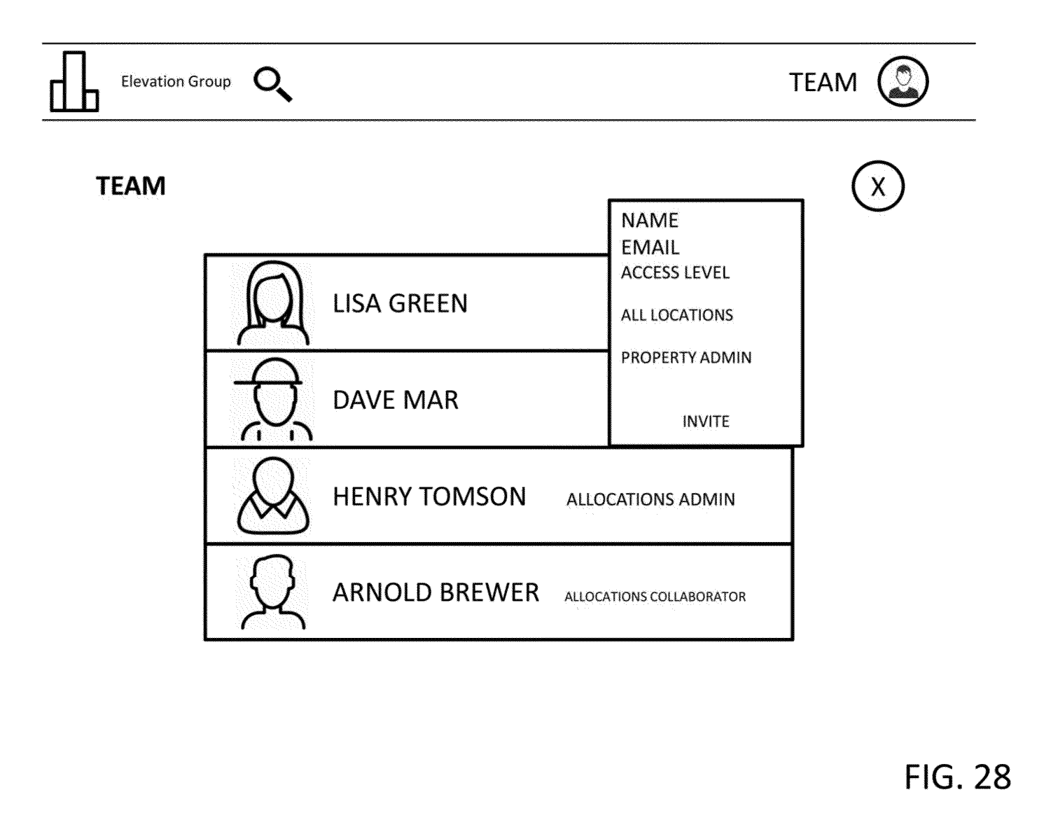

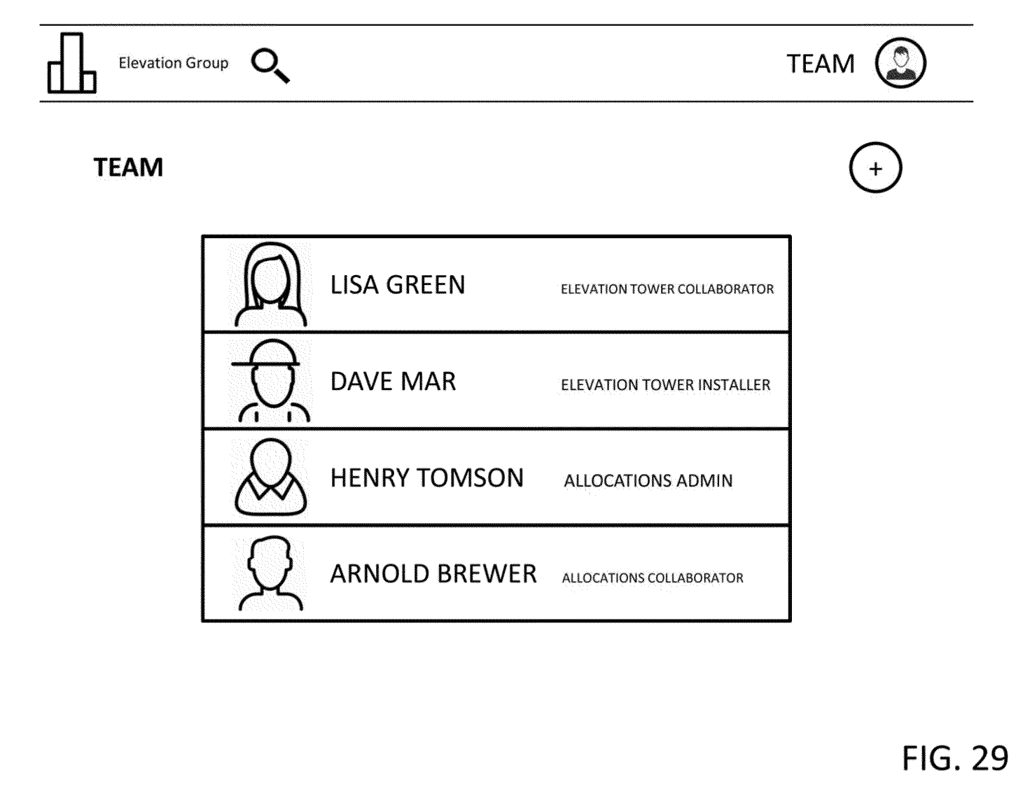

FIG. 28 is a screen from which the administrator can invite new team members. The invitation includes the name and email address of the invitee, as well as the access level the invitee will be given. Also, the title of the invitee is chosen. FIG. 29 is a list of current team members and their titles.

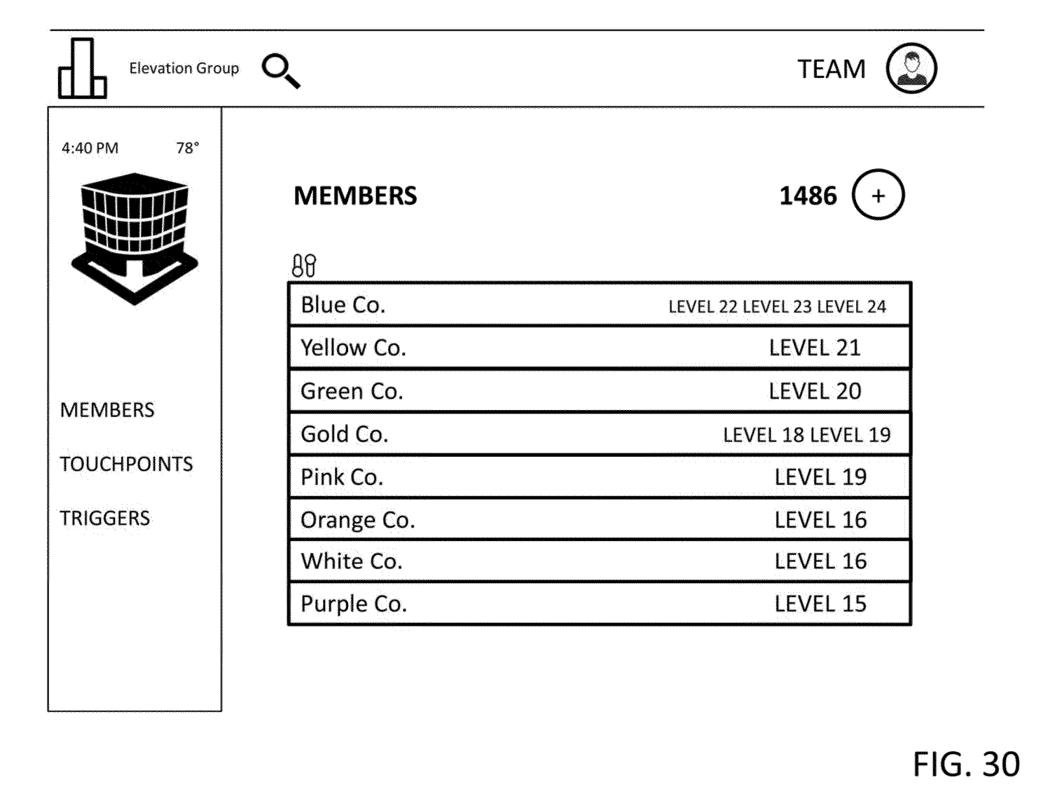

As previously stated member are tenants or employees of the building who arc invited to download the mobile app and use the EMAR system and service to have seamless access to the building. FIG. 30 is a list of members and the levels of the building they can access. There are 1486 current members.

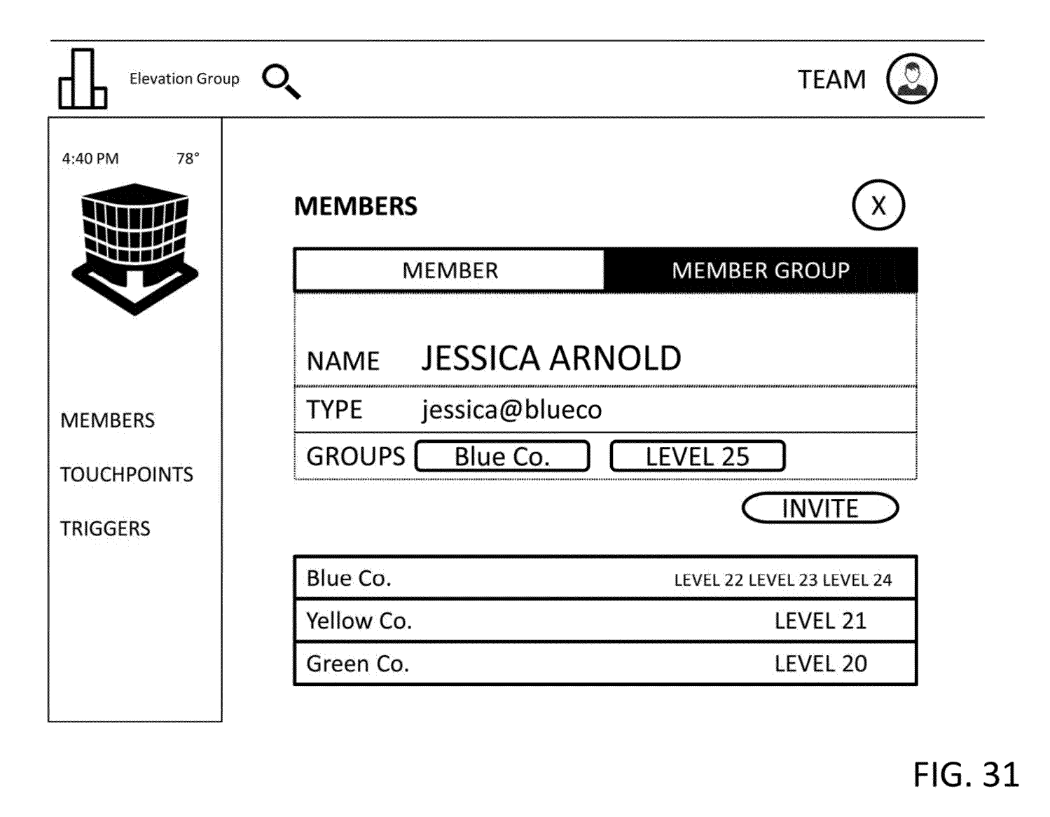

FIG. 31 is a screen from which a new member can be invited. The name and email address of the invitee as well as any groups they will belong to and levels to which they will have access are chosen. Then the invitation can be sent.

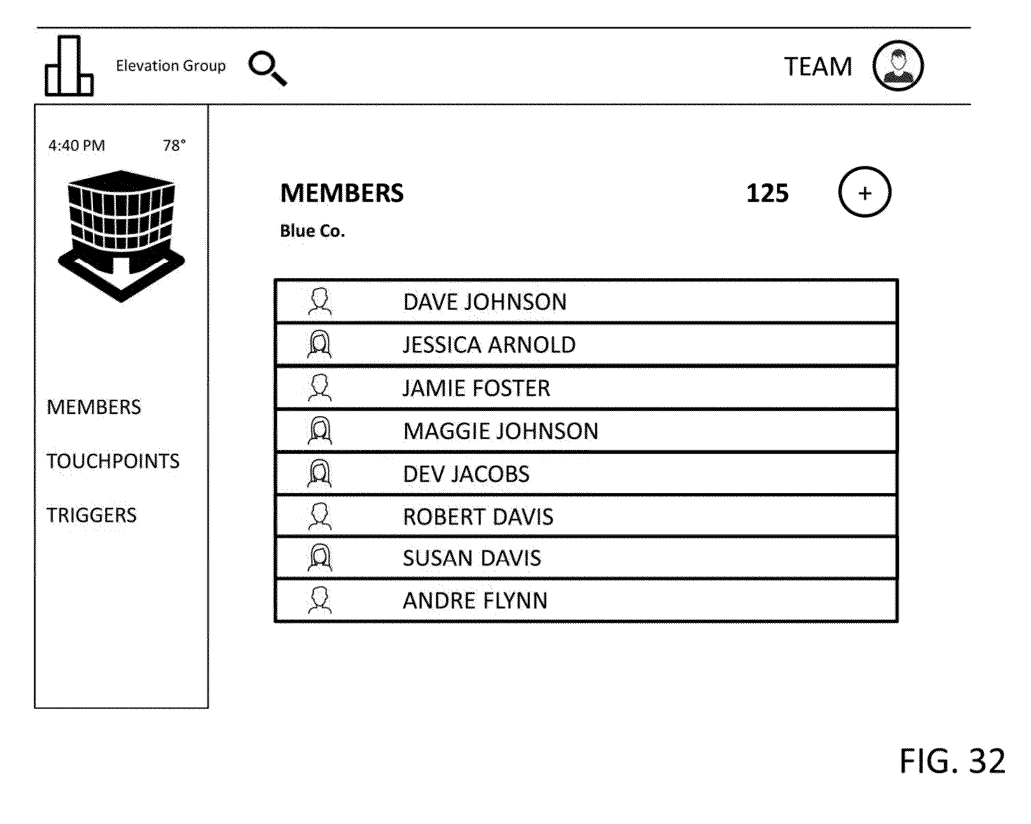

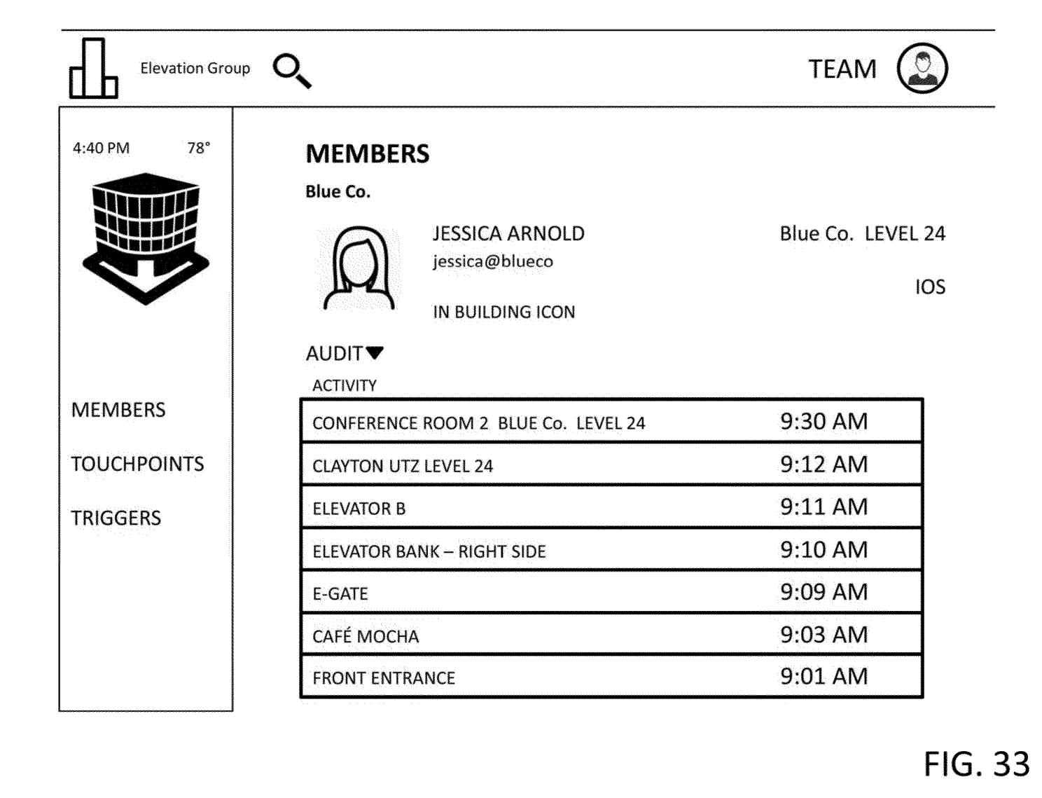

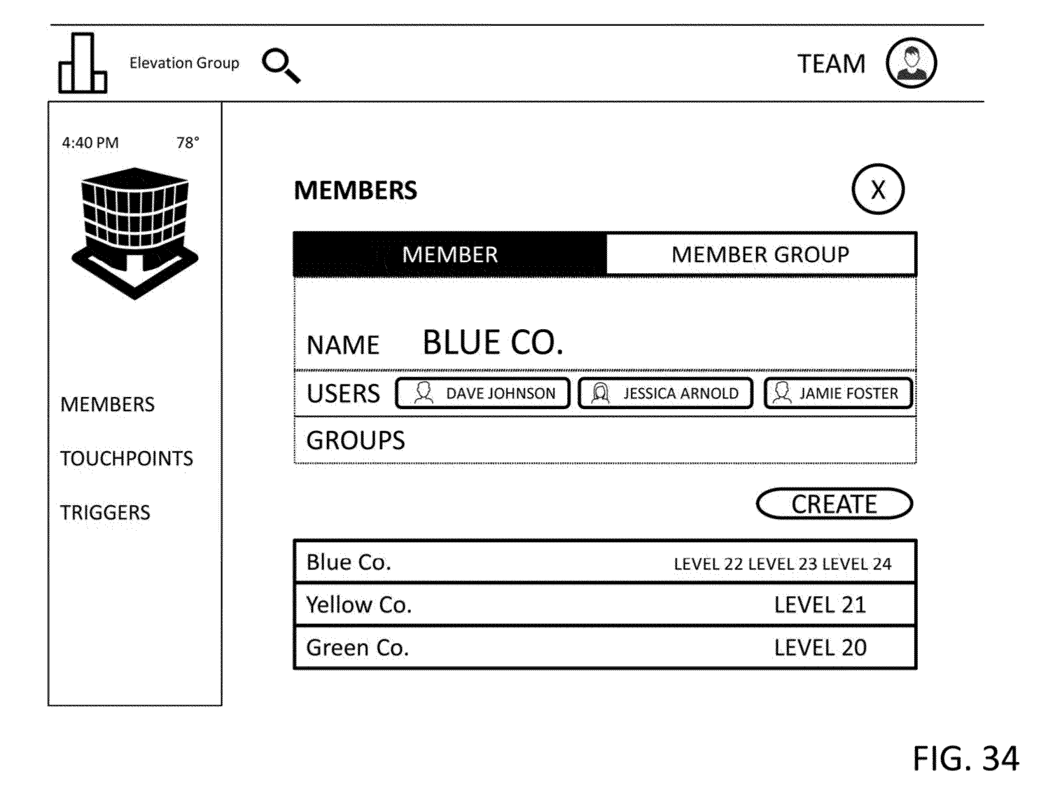

FIG. 32 is a list of all members of the Blue Co. group of users of the EMAR system in the building. FIG. 33 is a user profile of a member of the Blue Co. group. This includes an audit of the group member's activities according to what triggers were activated by the member and when. FIG. 34 shows creating a member group. The users are chosen as well as the name of the group.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific Integrated circuits (ASICs). Some other possibilities for implementing aspects of the system include; microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the internet and/or other computer networks via one or more data transfer protocols (e.g., HTTP, FTP, SMTP, etc.). When received within a computer system via one or more computer-readable media, such data, and/or instruction-based expressions of components and/or processes under the system described may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise forms disclosed. While specific embodiments of, and examples for, the systems components and methods are described herein for Illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

Many different implementations with accompanying embodiments are possible some of the implementations include the following.

Specific examples of use of an EMAR system will be described herein, however many more uses are possible including but not limited to the following. The EMAR system can be used in travel. In a hotel the EMAR (IBA) system can be used for automated hotel check-in, doors/guest room door access, elevator access, dining and bar payment and age verification, room service payment and age verification, for payment and access to parking, for controlling HVAC preferences, for automated lighting based on user preferences, for control of internet of things technologies based on presence and preference, for access to leisure facilities and for maintenance tracking and access. In an airport or airplane the EMAR (IBA) system can be used for bag drop which integrates with central reservation system, for check-in which integrates with the central reservation system, for processing of travelers based on DOI that cheeks age verification, payment, loyalty status and tracks interaction, for access to the lounge with loyalty status and interactions tracking, and for boarding. The EMAR system can be used in the for car rentals as well. The EMAR system can be used for registration/pickup which integrates with a central reservation system and processes car pickup and checks drivers license and completes age verification, and can processes payment and track the interaction. The EMAR system can also do an identification check upon the rental exist by verifying the driver's license and tracks interactions. The EMAR system can also be used on cruise liners. On cruise liners the EMAR system could operate doors and integrate with an Access Control System to give access to doors and track interactions. It also could be used in dining and at the bar and integrate with a point of sales system to identify, order and transact payments and track interactions. Other uses include access to gym or other facilities and maintenance to give access to doors, elevators, turnstiles and boom gates to maintenance and tracks movement and interactions. The EMAR system on a cruise could also be used to control HVAC and lighting and integrate with a Building Management System and operate based on presence and preference and track interactions.

The EMAR system has uses in real estate as well. In commercial real estate EMAR can be placed throughout a commercial building, at access points such as turnstiles, elevators, doors and parking boom gates and within the building; in rooms, offices bathrooms and operational spaces. Tenants, tenant employees, visitors, contractors and anyone accessing the building can use their DOI to get permanent and temporary access and automation in the building. Based on their DOI the experience can open doors, automate surroundings such as calling an elevator based on the floor you work at and connecting to other equipment or devices based on your DOI such as personal preferences reflective lighting or HVAC. The EMAR can be used to integrate with the Access Control System by allowing control of doors, turnstiles, lighting, shades, windows, elevators and parking. The EMAR can be integrated with the Point of Sale System to identify, transact payments and track interaction in the dining room or bar. Also in real estate the EMAR can notify internet of things technologies of DOI, create access to the gym or other facilities, interact with concierge and give maintenance access to areas. It also can be integrated with the Visitor Management System and syncs with calendars, generate temporary access credentials and notify the party their visitor has arrived.

The EMAR system has uses in residential real estate as well. The EMAR can be used to integrate with the Access Control System by allowing control of doors, turnstiles, lighting, shades, windows, elevators and parking. Also in residential real estate the EMAR can notify internet of things technologies of DOI, create access to the gym or other facilities, interact with concierge and give maintenance access to areas. Like in commercial, It also can integrate with the Visitor Management System and syncs with calendars, generate temporary access credentials and notify the patty their visitor has arrived. In residential real estate the EMAR system can also provide package notification and mail room access.

Another environment that the EMAR system can be used is in educational institutions. In the education institution the EMAR can be used to integrate with the Access Control System by allowing control of doors, turnstiles, lighting, shades, windows, elevators and parking. Based on their DOI users at educational institutions can use EMAR to open doors, automate surroundings such as calling an elevator based on the floor you have class at and connecting to other equipment or devices based on your DOI such as personal preferences reflecting lighting or HVAC. In particular in educational intuitions the EMAR can track students and faculty attendance by taking a DOI of a physical space. Further uses in educational institutions and children centers include children tracking.

The EMAR system can be used in government buildings and military defense as well. In a government building or military site the EMAR (IBA) system can be used for automated door access, elevator access, dining and bar payment and age verification, for payment and access to parking, for controlling HVAC preferences, for automated lighting based on user preferences, for control of internet of things technologies based on presence and preference, and for maintenance tracking and access. The EMAR can be used to integrate with the Access Control System by allowing control of doors, turnstiles, lighting, shades, windows, elevators and parking.

The EMAR system can be used in libraries. In a library setting the EMAR system can be used to integrate with the Access Control System by allowing control of doors, turnstiles, lighting, shades, windows, elevators, for controlling HVAC preferences, for automated lighting based on user preferences and parking. Specifically for the library setting the EMAR can do book processing based on presence of DOI.

The EMAR system can be used in labs as well. In labs the EMAR (IBA) system can be used for automated door and turnstile access, elevator access, dining and bar payment and age verification, for payment and access to parking, for controlling HVAC preferences, for automated lighting, based on user preferences, for control of internet of things technologies based on presence and preference, and for maintenance tracking and access, The EMAR system in labs can be used to integrate with the Access Control System by allowing control of doors, turnstiles, lighting, shades, windows, elevators and parking.

Another location EMAR system can be used is in courthouses. In courthouses the EMAR system can be used to integrate with the Access Control System by allowing control of doors, turnstiles, lighting, shades, windows, elevators, for controlling HVAC preferences, for automated lighting based on user preferences and parking. It also can be integrated with the Visitor Management System and syncs with calendars, generate temporary access credentials arid notify the party their visitor has arrived. Specifically for the courthouse the EMAR system can handle attorney check-in and processing and can identify the courtroom they should appear in

Another location EMAR system can be used is in airports. In airports the EMAR system can be used to integrate with the Access Control System by allowing control of doors, turnstiles, lighting, shades, windows, elevators, for controlling HVAC preferences, for automated lighting based on user preferences, parking access and maintenance management. Specifically for airports the EMAR can identify bags and process them and tracks interactions to assist in baggage handling.

Another location EMAR system can be used is in places of worship. In places of worship the EMAR system can be used to integrate with the Access Control System by allowing control of doors, turnstiles, lighting, shades, windows, elevators, for controlling HVAC preferences, for automated lighting based on user preferences, parking access and maintenance management.

Another category that the EMAR system could work in is transportation. In the space of public and charter transportation buses, trains and fairies can be equipped with the EMAR system to handle ticketing by integrating with the ticketing system and processing travelers. Also for buses, trains and fairies the EMAR system can provide contextual, announcements based on presence and preference. Other areas of transportation that this could be used in are taxis, gas stations and bike share. In the taxi and gas station space payments can be handled by the EMAR system by integrating with the Point of Sale systems which process payments. In the bike sharing space the EMAR system can provide access to hikes when in proximity by locking or unlocking the bike.

Another location EMAR system can be used is in recreational facilities. In recreational facilities including stadiums, gyms, health clubs, theme parks, festivals, casinos, and ski resorts the EMAR system can be used to integrate with the Access Control System by allowing control of doors, turnstiles, lighting, shades, windows, elevators, for controlling HVAC preferences, for automated lighting based on user preferences, parking access and maintenance management. Specifically the EMAR system in stadiums can integrate with Point of Sale systems for payment processing and identification. Also in stadiums the EMAR system can guide ticker holders to their seating location. Specifically in gyms, the EMAR system can track the usage of fitness equipment for the users and the facilities. Also at a health club the EMAR system can be used to check-in members and integrate with the Customer Relationship Manager to track customer interactions. In theme parks the EMAR system can integrate with Point of Sale systems tor payment processing and identification and provide access to certain rides and track the interaction. For casinos the EMAR system can provide unique solutions including chip purchase for gamblers, slot machine usage and table game usage. In the casino environment the EMAR system can identify loyalty members, verity ages of gamblers, purchase of gaming currency and track interactions.

Industry can also use the EMAR system. The EMAR system can be used in mining, oil and gas, manufacturing, assembly centers, data centers, agriculture, aquaculture, warehousing and logistics centers, shipyards, and shipping. The EMAR system in industry can integrate with Occupational Health and Safety data to be complaint with regulations and connect with other devices and systems, it can create access points for automation, tracking, safety and compliance, and it also can track equipment and environment. Other specific possible uses include offshore platforms compliance, asset tracking, maintenance and operations. In the manufacturing space the EMAR system can aid in tracking, workflow optimization and product tracking. The EMAR system can also handle logistics to optimize fieldwork and make more efficient logistical operations. Also in agriculture, livestock can be managed with tagging, health sensors and behavior tracking.

Another location the EMAR system can be used is in retail environment. In retail environments including dining institutions, fast food, bars and clubs, coffee shops, clothing stores, big box stores, shopping malls, supermarkets, convenience stores, post offices, shipping stores, dry cleaners and storage units the EMAR system can be used to integrate with the Access Control System by allowing control of doors, turnstiles, lighting, shades, windows, elevators, for controlling HVAC preferences, for automated lighting based on user preferences, parking access and maintenance management. Others uses in retail environments include in shipping stores and post offices where the EMAR system can give access to PO Boxes and received packages by detecting the proximity of the owner. In retail environments such as big box stores inventory can also be tracked and alerts can be established to indicate inventory levels.

The EMAR system can also be used in the automotive space. The EMAR system can provide access to vehicles, access to car parking lots and payment for parking meters and toll booths.

The EMAR system can also be used in financial institutions such banks, automated tellers and in compliance. The EMAR system can be used in finance to give customers and employees access to certain areas and to certain accounts. The EMAR system at an automated teller can notify the ATM of customer presence and customer information and track the interaction. For compliance the EMAR system can verify identities of users and notify the bank of the user age, driver's license information and track interactions.

Another location the EMAR system, can be used is in healthcare environments. In healthcare environments including hospitals, ambulances, assisted living centers, rehabilitation centers and doctor offices the EMAR system can be used to integrate with the Access Control System by allowing control of doors, turnstiles, lighting, shades, windows, elevators, for controlling HVAC preferences, for automated lighting based on user preferences, parking access and maintenance management. Additional more possible uses in the healthcare space include patient tracking, health care records presentation to emergency response workers, insurance card and information tracking and patient check-in.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, hut instead the scope of the systems and methods is to be determined entirely by the claims.

While certain aspects of the systems and methods are presented below in certain claim forms, the Inventors contemplate the various aspects of the systems and methods in any number of claim forms. For example, while only one aspect of the systems and methods may be recited as embodied in machine-readable medium, other aspects may likewise be embodied in machine-readable medium. Accordingly, the inventors reserve the right to add additional claims after filing the application to pursue such additional claim forms for other aspects of the systems and methods.

What is claimed is:

1. An entity monitoring and recognition (EMAR) method, comprising:
a user interface receiving ingot from a human including information that will be used to allow an entity to participate in the EMAR method, wherein in an entity comprises one or more of the human, an object on whose behalf the human is interacting, and a living thing on whose behalf the human is interacting;
an entity monitoring and recognition (EMAR) unit at a site detecting the presence of the entity, and in response recognizing the entity and triggering an action, wherein the detection and recognition comprises the EMAR unit wirelessly communicating with a device associated with the entity without any action on the part of the entity, and wherein a site comprises a physical location;
storing the detection and recognition and associating the detection and recognition with the entity, a time of the detection and recognition, and a touchpoint within the site at which the detection and recognition occurred.
